(19) United States
(12) Patent Application Publication
(10) Pub. No.: US 2011/0041641 A1
(43) Pub. Date: Feb. 24, 2011

(54) Deformable Robotic Surface

(76) Inventor: David Aaron Bennett, Wellington (NZ)

Correspondence Address: LEWIS, RICE & FINGERSH, LC;ATTN: BOX IP DEPT., 600 Washington Ave., Suite 2500, ST LOUIS, MO, 63101, US

(21) Appl. No.: 12/679,224

(22) PCT Filed: Sep. 19, 2008
(86) PCT No.: PCT/NZ08/00245

§ 371 Date: Sep. 15, 2010

Related U.S. Application Data
(60) Provisional application No. 60/973,457, filed on Sep. 19, 2007.
(60) Provisional application No. 60/988,795, filed on Nov. 18, 2007.
(60) Provisional application No. 61/020,106, filed on Jan. 9, 2008.
(60) Provisional application No. 61/025,914, filed on Feb. 4, 2008.
(60) Provisional application No. 61/086,167, filed on Aug. 5, 2008.
(60) Provisional application No. 61/043,276, filed on Apr. 8, 2008.
(60) Provisional application No. 61/033,145, filed on Mar. 3, 2008.
(60) Provisional application No. 61/073,765, filed on Jun. 19, 2008.

(51) Int. Cl. G05G 11/00

(52) U.S. Cl. 74/490.08

(57) ABSTRACT

A deformable robotic surface has a plurality of control points 102, a plurality of connectors 104 extending between the control points, and a covering 106 extending over the plurality of control points. The control points 102 are moveable relative to each other. Movement of the control points 102 relative to each other causes a corresponding movement of the covering 106 and a corresponding movement of the control point connectors 104.

### BACKGROUND

1. Field of the Invention

This invention generally relates to robotics, specifically to deformable robotic surfaces.

2. Description of the Related Art

In the field of robotics, robotic toys and prosthetics, deformable surfaces have been created in the past. However, most of the current designs lack the control necessary to describe detailed deformable surfaces throughout a wide range of motion. This is because the robotic industry has focused more on function, rather than form.

In U.S. Pat. No. 7,113,848, David Hanson of Hanson Robotics, attempted to re-create realistic human facial movement in his robotic faces. His invention comes short in reproducing realistic facial movement, since the method he uses to move the skin lacks the level of control necessary to reach the full range of motion in human facial expression.

Professor Hiroshi Ishiguro, of Osaka University, built two humanoid robots called Repliee Q1Expo and Geminoid. Both of these androids could pass as human, from a distance, but when the android moves, the illusion is shattered. This happens because the underlying muscles of the organism are not being reflected in the android's skin. His work would be improved, if he were to re-create the humans' full range of motion by using a method that would allow all of the appropriate deformations to be made.

Deformable robotic surface could be used to create surfaces for, but are not limited to: artificial organisms, robotic toys, surfaces for prosthetics, ability to morph one surface to another, deformable objects.

In this specification where reference has been made to patent specifications, other external documents, or other sources of information, this is generally for the purpose of providing a context for discussing the features of the invention. Unless specifically stated otherwise, reference to such external documents or such sources of information is not to be construed as an admission that such documents or such sources of information, in any jurisdiction, are prior art or form part of the common general knowledge in the art.

An object of at least preferred embodiments of the invention is to provide a deformable robotic surface that is capable of mimicking an organism's surface deformations throughout its range of motion, or to at least provide the public with a useful choice.

### SUMMARY

In accordance with a first aspect of the present invention, there is provided a deformable robotic surface comprising: a plurality of control points, the control points being moveable relative to each other; and a covering extending between the plurality of control points; wherein movement of the control points relative to each other causes a corresponding movement of the covering.

Preferably, the deformable robotic surface further comprises a plurality of connectors extending between the control points, wherein movement of the control points relative to each other causes a corresponding movement of the control point connectors.

Preferably, at least a portion of the plurality of connectors comprise flexible connectors.

Preferably, at least a portion of the plurality of connectors comprise resilient connectors.

Preferably, at least a portion of the plurality of connectors comprise rigid connectors.

Preferably, the rigid connectors comprise telescopic connectors.

Preferably, at least a portion of the control point connectors are generally straight components.

Preferably, at least a portion of the control point connectors are generally curved components.

Preferably, the covering comprises a flexible covering.

Preferably, the covering comprises a resilient covering.

Preferably, the covering extends over the control points and the plurality of control point connectors.

Preferably, the control points are generally arranged in rows and columns to form a grid of control points.

Preferably, the control points connectors extend between adjacent control points to form a grid of control points and control point connectors.

Preferably, the deformable robotic surface further comprises at least one actuator for moving at least one of the control points relative to the other control points.

Preferably, the control point connectors comprise actuator(s) that are adapted to move the control points relative to each other.

Preferably, the actuator(s) comprises biasing means. More preferably, the biasing means comprises a spring. Alternatively, the actuator(s) comprises electroactive polymers. Alternatively, the actuator(s) comprises pneumatic actuator(s).

Preferably, the actuator(s) are attached to the covering, control points, or control point connectors at attachment points.

Preferably, the control points comprise actuator(s) that are adapted to move the control points relative to each other.

Preferably, the actuator(s) comprise biasing means. More preferably, the biasing means comprises a spring. Alternatively, the actuator(s) comprises electroactive polymers.

Preferably, the deformable robotic surface further comprises at least one flexible support extending from a control point towards the covering to form a relatively smooth surface in the covering.

Preferably, at least a portion of the control point connectors are embedded in the covering.

Preferably, at least a portion of the control points are embedded in the covering.

Preferably, the control points are rotatable relative to the covering.

Preferably, the deformable robotic surface has a neutral configuration in which at least a majority of the covering is generally non-planar. More preferably, the deformable robotic surface has a neutral configuration in which at least a portion of the covering is generally curved. Alternatively, the deformable robotic surface has a neutral configuration in which at least a majority of the covering is generally planar.

Preferably, the deformable robotic surface further comprises at least one additional layer or skin. More preferably, the additional layer or skin covers at least a portion of the covering.

Preferably, the deformable robotic surface further comprises sensors and wiring to transfer data or energy.

Preferably, the control points are integrally formed with the covering.

Preferably, the control point connectors are integrally formed with the covering.

Preferably, the location of at least a portion of the control points and at least a portion of the control point connectors is printed on the covering.

Preferably, the control points are integrally formed with the control point connectors as an expandable and contractible web.

Preferably, the control points correspond to vertices of a computer representation, the covering corresponds to a face or series of faces of the computer representation.

Preferably, the control points correspond to vertices of a computer representation, the control point connectors correspond to edges of the computer representation, the covering, additional layer, or exterior surface corresponds to a face or series of faces of the computer representation.

Preferably, the expandable and contractible web correspond to edges of the computer representation.

Preferably, the attachment point(s) of the actuators correspond to vertices of a computer representation.

Preferably, the movement of the control points or attachment points through time generally correspond to a computer represented movement of the vertices of the computer representation throughout time.

Preferably, the movement of the control points connectors or expandable and contractible web through time generally correspond to a computer represented movement of the edges of the computer representation throughout time.

Preferably, the movement of the covering, additional layer, or exterior surface through time generally correspond to a computer represented movement of the faces of the computer representation throughout time.

In accordance with a second aspect of the present invention, there is provided a combination of a deformable robotic surface as described in relation to the first aspect attached to at least one other deformable robotic surface as described in relation to the first aspect.

In accordance with a third aspect of the present invention, there is provided a combination of a deformable robotic surface as described in relation to the first aspect attached to at least one other item.

Preferably, the other item is part of a robot. More preferably, the deformable robotic surface forms the exterior surface or artificial skin of the robot.

In accordance with a third aspect of the present invention, there is provided an artificial muscle comprising a deformable robotic surface as described in relation to the first aspect.

Preferably, the artificial muscle further comprises an artificial muscle core wherein the deformable surface at least partially surrounds the artificial muscle core.

The term “comprising” as used in this specification means “consisting at least in part of”; that is to say when interpreting statements in this specification which include “comprising”, the features prefaced by this term in each statement all need to be present but other features can also be present. Related terms such as “comprise” and “comprised” are to be interpreted in a similar manner.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting. Where specific integers are mentioned herein which have known equivalents in the art to which this invention relates, such known equivalents are deemed to be incorporated herein as if individually set forth.

As used herein the term “(s)” following a noun means the plural and/or singular form of that noun.

As used herein the term “and/or” means “and” or “or”, or where the context allows both.

The invention consists in the foregoing and also envisages constructions of which the following gives examples only.

### BRIEF DESCRIPTION OF FIGURES

The present invention will now be described with reference to the accompanying drawings in which:

FIG. 1 is an exploded perspective view of a first preferred embodiment of the deformable robotic surface;

FIG. 2 is a view of an organism's thigh musculo skeletal system and a corresponding thigh of a deformable robotic surface;

FIG. 3a is a front view of an organism's face;

FIG. 3b is a front view of the organism's face of FIG. 3b together with an overlying layout of control points and control point connectors;

FIG. 3c is the layout of control points and control point connectors of FIG. 3b without the organism's face;

FIG. 4a is a perspective view of a 3d computer representation of polygons;

FIG. 4b is a perspective view of a deformable robotic surface corresponding to the computer representation of FIG. 4a;

FIG. 4c is a perspective view of the computer representation of FIG. 4a with new vertex positions;

FIG. 4d is a perspective view of a deformable robotic surface corresponding to the computer representation of FIG. 4c;

FIG. 5 is a view of an internal and external deformable robotic surfaces;

FIG. 6a is a schematic of a human being;

FIG. 6b shows the layout of a human being's muscular system;

FIG. 6c is the layout of control points, control point connectors, and coverings corresponding to the muscular system shown in FIG. 6b;

FIG. 7 is perspective view of the preferred embodiment deformable robotic surface of FIG. 1 with additional layers or artificial skins;

FIG. 8a shows the pneumatic actuator in a deflated configuration;

FIG. 8b is a side view of a pneumatic actuator of FIG. 88a in an inflated configuration;

FIG. 9a is a perspective view of an alternative embodiment deformable robotic surface having an electroactive polymer actuator in an undeformed state;

FIG. 9b is a perspective view of the alternative embodiment deformable robotic surface of FIG. 9a in a deformed state;

FIG. 10 shows deformable robotic surface equivalents of characterized faces;

FIG. 11 shows an organism's face and corresponding deformable robotic surface together with the face of a different organism and corresponding deformable robotic surface which a single robotic surfaces between the two;

FIG. 12 illustrates a method to mix different organisms together to create a deformable robotic surface;

FIG. 13 shows deformable robotic surface equivalents of an organism with a non-proportional scale applied;

FIG. 14 is a perspective view of control points and a control point connector with a flexible support material;

FIG. 15 is a view of a deformable robotic surface equivalent of a Quadrilateral Muscle;

FIG. 16 is a view of a deformable robotic surface equivalent of a Strap Muscle;

FIG. 17 is a view of a deformable robotic surface equivalent of a Strap with tendinous;

FIG. 18 is a view of a deformable robotic surface equivalent of a Unipennate muscle;

FIG. 19 is a view of a deformable robotic surface equivalent of a Multi-pinnate muscle;

FIG. 20 is a view of a deformable robotic surface equivalent of a Triangular muscle;

FIG. 21 is a view of a deformable robotic surface equivalent of a Muscle Plates deformable robotic surface equivalent;

FIG. 22 is a view of a deformable robotic surface equivalent of a Fusiform muscle;

FIG. 23 is a view of a deformable robotic surface equivalent of a Biventer;

FIG. 24 is a view of a deformable robotic surface equivalent of a Tricipital;

FIG. 25 is a view of a deformable robotic surface equivalent of a Bipennate muscle;

FIG. 26 is a view of deformable robotic surface equivalent of a Spiral muscle plates;

FIG. 27 is a view of a deformable robotic surface equivalent of multiple muscles;

FIG. 28 is a perspective view of an alternative rotational control point design;

FIG. 29 is a perspective view of an alternative rotational control point design;

FIG. 30 a view of control points and control point connectors forming a network;

FIG. 30B is a view of a covering, additional layer or external surface forming a network;

FIG. 31 shows alternative control point densities used to define the same surface;

FIG. 32 is a perspective view of an alternative rotational control point design;

FIG. 33 is a perspective view of another alternative rotational control point design;

FIG. 34 is a perspective view of a curved control point connector;

FIG. 35 is a front view of deformable robotic surface equivalents of an organism in which the proportions have been altered;

FIG. 36 is a perspective view of a non-deformable robotic surface combined with a deformable robotic surface;

FIG. 37 shows 3d scans of an organism;

FIG. 38 is a perspective view of a control point connector as an actuator in unexpanded and expanded configurations;

FIG. 39 is a perspective view of control point connectors as actuators in the form of electroactive polymers;

FIG. 40 is a perspective view of an example of a rigid control point connector in the form of a telescopic tube;

FIG. 41a is a perspective view of an actuating surface support in relaxed configuration;

FIG. 41b is a perspective view of an actuating surface support in deformed or actuated configuration;

FIG. 41c is a perspective view of an embedded bendable wire connector;

FIG. 42 is a front view of an actuator with flexible bases;

FIG. 43a is a perspective view of deformable robotic surfaces detached;

FIG. 43b is a perspective view of the deformable robotic surfaces attached

FIG. 44a is a perspective view of locking control points

FIG. 44b is a perspective view of re-attachable edges of a covering

FIG. 44 is a flowchart for creating an artificial organism;

FIG. 45 additional actuation from a control point;

FIG. 46a is a perspective view of electroactive polymer in a relaxed state;

FIG. 46b illustrates the electroactive polymer of FIG. 46a in a deformed state;

FIG. 47a is a perspective view of another alternative embodiment of the deformable robotic surface having curved rigid control point connectors in an unexpanded configuration;

FIG. 47b is a perspective view of another alternative embodiment of the deformable robotic surface having curved rigid control point connectors of FIG. 47a in an expanded configuration

FIG. 48a is a perspective view of alternative curved rigid control point connectors in an unexpanded configuration;

FIG. 48b is a perspective view of the curved rigid control point connectors of FIG. 48a in an expanded configuration;

FIG. 49a is a perspective view of the curved rigid control point connectors in an expanded configuration;

FIG. 49b is a perspective view of alternative curved rigid control point connectors of FIG. 49a in an unexpanded configuration;

FIG. 50a is a perspective view of an alternative embodiment of the deformable robotic surface in which the control points are embedded into a covering, additional layer or external surface;

FIG. 50b is a side view of the deformable robotic surface of FIG. 50a;

FIG. 51a is a perspective view of an alternative embodiment of the deformable robotic surface in which the control points attached to a covering, additional layer or external surface;

FIG. 51b is a side view of the deformable robotic surface of FIG. 51a;

FIG. 52a is a perspective view of an alternative embodiment of the deformable robotic surface in which the control points and control point connectors are embedded into a covering, additional layer or external surface;

FIG. 52b is a side view of the deformable robotic surface of FIG. 52a;

FIG. 53a is a perspective view of an alternative embodiment of the deformable robotic surface in which the control points and control point connectors attached to a covering, additional layer or external surface;

FIG. 53b is a side view of the deformable robotic surface of FIG. 53a;

FIG. 54a is a perspective view of an alternative embodiment of the deformable robotic surface in which an expanding and contracting web embedded into a covering, additional layer or external surface;

FIG. 54b is a side view of the deformable robotic surface of FIG. 54a;

FIG. 55a is a perspective view of an alternative embodiment of the deformable robotic surface in which an expanding and contracting web attached to a covering, additional layer or external surface;

FIG. 55b is a side view of the deformable robotic surface of FIG. 55a;

FIG. 56a is a perspective view of an alternative embodiment of the deformable robotic surface in which the control points are embedded into an expanding and contracting web;

FIG. 56b is a side view of the deformable robotic surface of FIG. 56a;

FIG. 57a is a perspective view of an alternative embodiment of the deformable robotic surface in which the control points are attached to an expanding and contracting web;

FIG. 57b is a side view of the deformable robotic surface of FIG. 57a;

FIG. 58a is a perspective view of an alternative embodiment of the deformable robotic surface in which an actuation system is embedded into a covering, additional layer or external surface;

FIG. 58b is a side view of the deformable robotic surface of FIG. 58a;

FIG. 59a is a perspective view of an alternative embodiment of the deformable robotic surface in which an actuation system is attached to a covering, additional layer or external surface;

FIG. 59b is a side view of the deformable robotic surface of FIG. 59a;

FIG. 60a is a perspective view of an alternative embodiment of the deformable robotic surface in which an actuation system and an expanding and contracting web embedded into a covering, additional layer or external surface;

FIG. 60b is a side view of the deformable robotic surface of FIG. 60a;

FIG. 61a is a perspective view of an alternative embodiment of the deformable robotic surface in which an actuation system and an expanding and contracting web are attached to a covering, additional layer or external surface;

FIG. 61b is a side view of the deformable robotic surface of FIG. 61a; and

FIG. 62 shows a method of printing the location of control points and control point connectors on a deformable robotic surface.

### DETAILED DESCRIPTION OF A PREFERRED EMBODIMENT

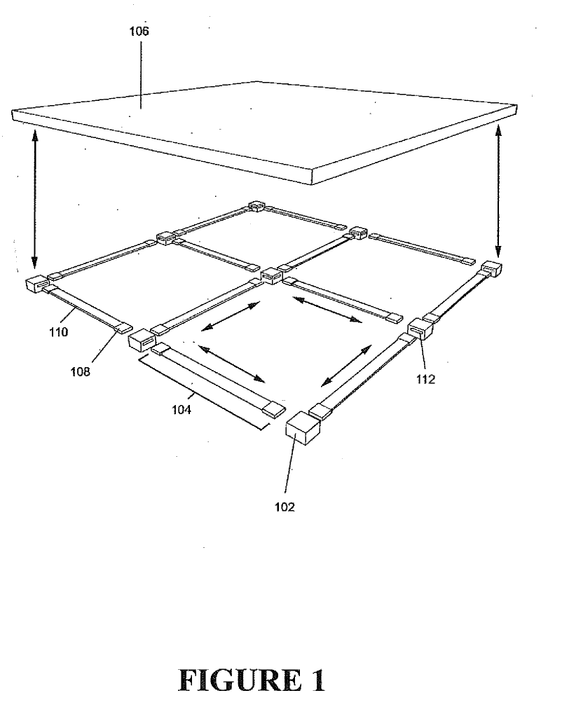

Details of a first preferred embodiment of the present invention are illustrated in FIG. 1. FIG. 1 is an exploded perspective view of a deformable robotic surface and illustrates a deformable robotic surface comprising control points 102, control point connectors 104 extending between the control points, and a covering 106 extending between the control points and the control point connectors. In the preferred embodiment, the covering extends over the control points and control point connectors. The control points are spaced apart from each other and moveable relative to each other.

Movement of the control points 102 relative to each other causes a corresponding movement of the covering 106. Movement of the control points 102 relative to each other causes a corresponding movement of the control point connectors 104. The control points 102 are spaced apart from each other generally in rows and columns. However, this arrangement of rows and columns may be altered depending on the intended shape and use of the robotic surface, as described later in this specification. The control point connectors extend between adjacent control points to from a generally grid shaped pattern.

The use of the reference number 102, 104, 106 are used as a generic reference numbers to describe various control points 102, control point connectors 104, and coverings 106 designs listed in this specification, since various designs for each of these parts can be used to create various deformable robotic surfaces.

### Control Points

The control points 102 are objects or elements in which an actuation/artificial muscle system can be attached to in order to deform the deformable robotic surface. The control points can perform many other functions, which are listed throughout this specification. The control points are generally block shaped components as shown in FIG. 1 with four side walls, a top wall, and a bottom wall. The control points have apertures or slots 112 formed in one or more of the side walls for receiving the end of corresponding control points.

In the preferred embodiment of the invention, the control points 102 are attached underneath the covering such that movement of the control points relative to each other causes a corresponding movement of the covering.

The deformable robotic surface can require different control point 102 designs depending on the actuation system used and the type of surface desired. Sometimes, it can be useful to use multiple types of control points 102 to build a single deformable robotic surface. Many factors can determine which type control point 102 is most effective for a specific location of the deformable robotic surface, some determining factors can be, but are not limited to: size, strength, flexibility, type of connector needed to connect to the actuation system, cost, range of motion desired, attachments needed for connectors and covering, attachment of electrical wires, attachments for sensors, the actuation system used to deform the deformable robotic surface, (the type of deformation desired, whether or not the control points and control point connectors form a networked web, the desired function of the control point.

### Alternative Control Point Designs

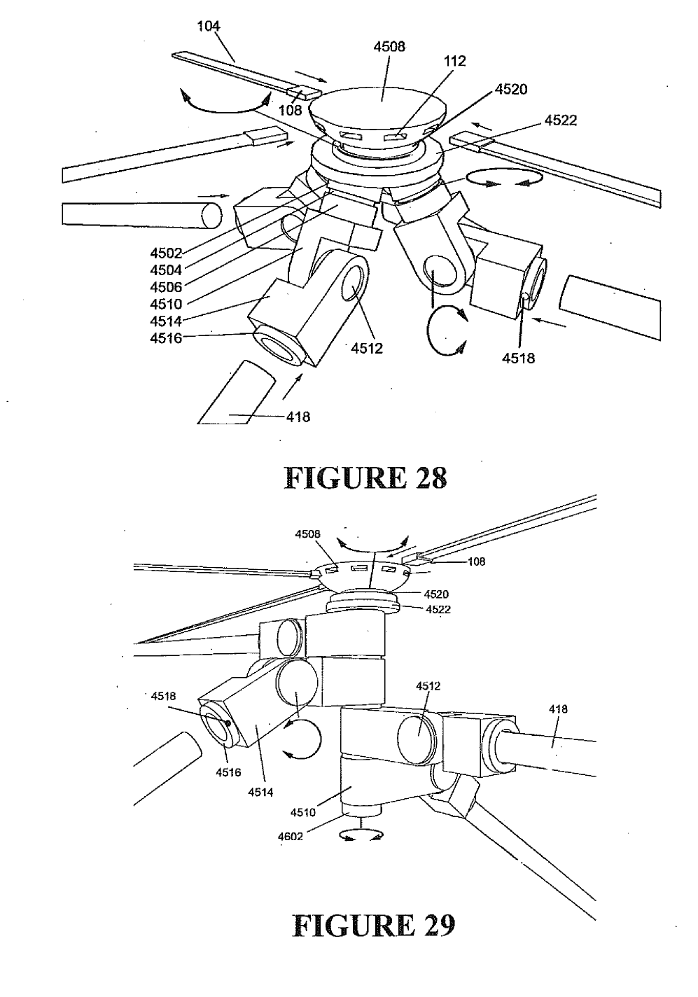

FIGS. 28, 29, 32, and 33 illustrate some alternative control point designs. These designs show some of the various ways that control points 102 can be created. Since control points 102 can be designed in many different ways, the control point 102 designs should not be limited to the ones listed in the preferred embodiment.

The control point designs shown in FIGS. 28 and 29 can be useful in deforming a large portion of the deformable robotic surface. This is because these designs can created more durably, but these designs would be larger than some of the other alternative designs.

FIG. 28 shows a rotational control point design. The control point has a control point head 4508 with apertures or slots 112 for receiving the ends of control point connectors. The rotational head pivot is supported by a rotational head platform 4522 and is rotatably mounted to the rotational head platform 4522 by a rotational head pivot in the form of a uniball 4520. One or more actuators 418 are operatively connected to the control point via bearings and rotational arms. In the embodiment shown, the control point has a first rotational arm 4510 that is pivotally connected to a second rotational arm 4514 via a bearing pivot 4512. The first rotational arm 4510 is connected to the rotational head platform 4522 via a base connector 4502, a bearing 4504, and a bearing connector 4506. The or each actuator 418 is insertable in a corresponding actuation connector 4516 or control point connector fastener 4518 for connecting the actuator to the second rotational arm 4514.

FIG. 29 is a perspective view of an alternative rotational control point design that has similarities to the rotational control point design described in relation to FIG. 28. Unless described below, the features and operation should be considered to be the same as those described above in relation to FIG. 28 and like numerals are used to indicate like parts.

This alternative rotational control point design has a control point head 4508 with apertures or slots 112 for receiving the ends of control point connectors. The rotational head pivot is supported by a rotational head platform 4522 and is rotatably mounted to the rotational head platform 4522 by a rotational head pivot in the form of a uniball 4520. One or more actuators 418 are operatively connected to the control point via bearings and rotational arms. In the embodiment shown, each actuator is connected to the control point by a first rotational arm 4510 and a second rotational arm 4514. The rotational arms are pivotally connected together via a bearing pivot 4512. The first rotational arm 4510 is connected to the rotational head platform 4522 via a central spindle 4602. Arrows in FIG. 29 indicate the relative movement of the components of this alternative rotational control point design.

The or each actuator 418 is insertable in an actuation connector 4516 or control point connector fastener 4518 for connecting the actuator to the second rotational arm 4514.

FIG. 32 is a perspective view of an alternative rotational control point design that has similarities to the rotational control point design described in relation to FIGS. 28 and 29. Unless described below, the features and operation should be considered to be the same as those described above in relation to FIGS. 28 and 29 and like numerals are used to indicate like parts.

This alternative rotational control point design has a control point head 4508 with apertures or slots 112 for receiving the control point connector ends 108. The rotational head pivot is supported by a control point base 5204 and is fixed to the control point base. One or more actuators 418 are connected to the control point base. In the embodiment shown, each actuator is insertable and securable in corresponding artificial muscle connectors 5304. The circular arrows represent the allowable movement of the various components of the rotational control point.

The control point design in FIG. 32 is useful when a smaller and/or denser control point layout is needed. The uniball bearings 5202 allow a rotational pivot from a single point.

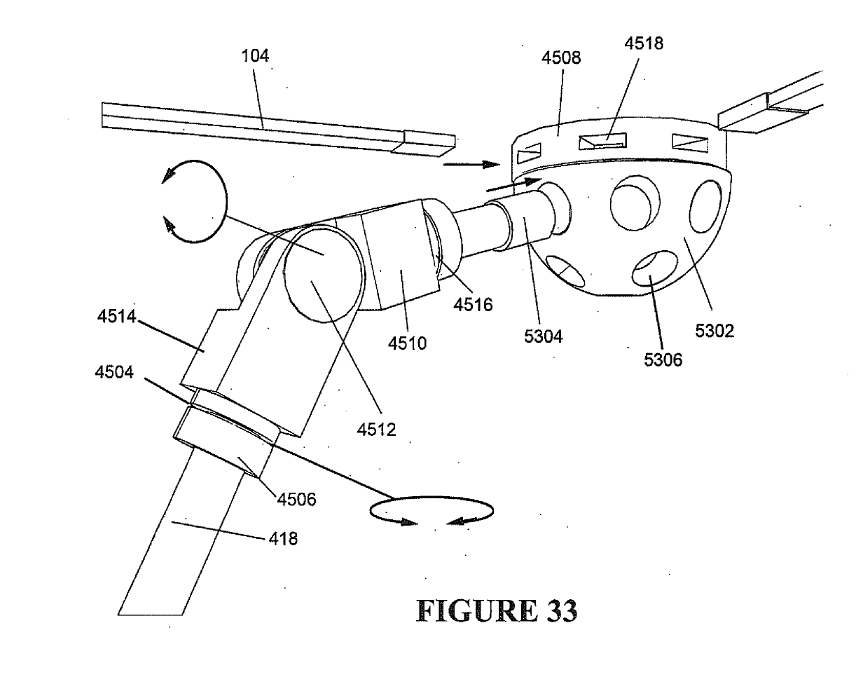

FIG. 33 shows a further alternative rotational control point design. Unless described below, the features and operation should be considered to be the same as those described above in relation to FIGS. 28, 29, and 32 and like numerals are used to indicate like parts.

The rotational control point shown in FIG. 33 has a control point head 4508 with apertures or slots 112 for receiving the ends of control point connectors. The rotational head pivot is connected to an artificial muscle connection point 5302. The artificial muscle connection point is generally semi-spherical in shape. One or more actuators 418 are operatively connected to the control point via rotational arms. In the embodiment shown, the control point has a first rotational arm 4510 that is pivotally connected to a second rotational arm 4514 via a bearing pivot 4512. The first rotational arm 4510 is connected to the artificial muscle connection point 5302 via an actuation connector 5304. The actuation connector (male) 5304 is insertable and securable into the actuation connector slot (female) 5306 to attach the actuator to the control point 102.

Each actuator 418 is insertable in an actuation connector 4516 for connecting the actuator to the second rotational arm 4514. The actuation connector 4516 is connected to the second rotational arm 4514 via a bearing connector 4506 a bearing 4504.

The control point design in FIG. 33 can be very small relative to the size of other rotatable control point designs since the rotational pivots are not located on the control point. That is because the rotational pivots are located on the arm that connects to the control point.

The control points 102 can be made out of variety of materials which can include, but are not limited to: metals, plastics, rubber, wood, or carbon fibre, for example.

Additional Actuation from Control Points

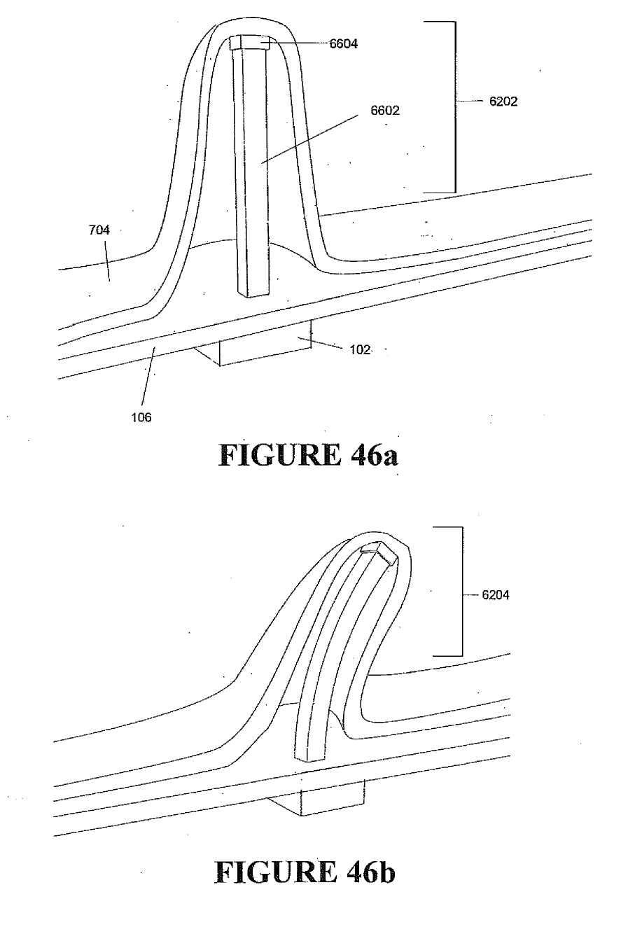

An alternative embodiment actuator is shown in FIGS. 46a and 46b. In this alternative embodiment, additional actuation can be created from the covering 106, when an actuator, in the form of an electroactive polymer 6602, is attached to the covering 106. This can be useful when additional actuation is needed beyond the control point(s) 102 and control point connector(s) 104. This is particularly useful when the control point(s) 102 control point connector(s) 104, are too large to physically to fit into a space, the additional actuator can still create the desired deformations on from the covering 106 and effect the surface deformations of the exterior surface 704. FIG. 46a illustrates the electroactive polymer in a non-deformed state 6602 and FIG. 46b illustrates the electroactive polymer in a deformed state 6204 with the voltage turned on. The actuator is preferably positioned above or near a control point 104.

Additional actuation could be created from many other types of actuators, as well, which can include but is not limited to: pneumatic actuation, hydraulic actuation, magnetic actuation, mechanical actuation, piezoelectric actuation, electro-mechanical actuation, and fiber reinforced rubber actuators driven hydraulically or pneumatically, for example.

Electroactive polymers are polymers whose shape is modified when a voltage is applied to the polymer. Electroactive polymers can be used as actuators or sensors. As actuators, electroactive polymers are able to undergo a large amount of deformation while sustaining large forces.

In the embodiment shown, the electroactive polymer 6602 has an attachment point 6604 that is located on top of the electroactive polymer 6602 adjacent the exterior surface 704, that can be used to bind the covering 106 to the electroactive polymer 6602. Products that could attach the surfaces together could be, but should not be limited to: super glue, epoxies, elastomer adhesives, other adhesives, alternative methods of actuation could be used to create a similar effect.

### Control Points Connectors

The control point connectors 104 are flexible or rigid parts that attach to the control points 102 together to form a connected control point web. The control point connectors are elongate components and extend between adjacent control points to form a generally grid shaped arrangement having rows and columns.

In the preferred embodiment shown in FIG. 1, the control point connectors 104 have a generally rectangular cross-section. The cross section is preferably substantially constant along the length of the control point connector. The control point connectors have expanded ends 104a that are insertable into corresponding apertures or slots 112 in the control points.

The control point connectors 104 can be used in many different ways to enhance the robotic surface's deformability and functionality; these enhancements can include, but are not limited to:
Transferring data, energy, sensors etc. through the connective web of control points and control point connectors
Supporting the covering 106
Smoothing the surface of the covering 106
Limiting the amount of distance the control points 102 travel
Actuation of the control points 102
Curving the surface of the covering 106
Providing rotational pivots 408

The control point connectors 104 can be attached to the control points 102 and the covering 106 in many ways. Since there are different control points 102 and control point connectors 104 and coverings 106 that can be used to create various deformable robotic surfaces with, the method of attachment depends on what type of control point 102 control point connectors 104 and covering 106 are being used to create the deformable robotic surface with. For example, adhesives could be added to the covering 106 to adhere the covering 106 to the control points 102 and control point connectors 104. Alternative products that could used to attach the control points 102 and control point connectors 104 to the covering 106 could be, but should not be limited to: various glues epoxies, elastomer adhesives, other suitable adhesives, hook and loop fasteners, threaded stitches, for example.

### Flexible Control Point Connectors

In the preferred embodiment shown in FIG. 1, the control point connectors are flexible control point connectors. In FIG. 1, the flexible control point connectors 104 consist of a pair of control point connector ends 108 and a control point expander 110. Each control point connector end 108 is a male component that is insertable and securable into the corresponding female slot 112 of the control point 102. The control point expander 110 preferably comprises an elastic material so that it can expand and contract with the movement applied by the actuation system. The control point connector end 108 and the female slot of the control point 112 may comprise magnetic components, metallic or plastic components, or interlocking clips, for example. Additionally, the control point connector ends 108 may be a female component and the control point may have a corresponding male component.

Alternatively, the control point expander 110 may be directly connected to the control point. The male end of the control point connector ends 108 could be made from a plastic wire connector. However, many other alternative embodiments of the control point connector ends 108 could be created as well. The preferred connector will be determined by, but is not limited to, these factors: type of control point used, type of control point expander used 110 what kind of energy, actuation, or data needs to be transferred through the network.

The flexible control point connectors 104 can aid in limiting the distance the control points 102 move by providing an elastic, flexible tension between the control points 102. These flexible control point connectors 104 can also aid in supporting the covering 106 and defining the coverings 106 surface by adding structure to a control point 102/control point connector 104 web, which the surface gets attached to. The flexible, elastic qualities needed for each control point connector 104 can vary, since each connection may need to be unique in that particular region of the deformable robotic surface. Some factors that can determine the elastic qualities needed of the control point connector 104 can be, but are not limited to the distance that the control points 102 need to travel, and the resistance created by the connected parts, for example.

Once these factors have been taken into consideration, the appropriate flexible control point connector 104 can be determined and used for that particular group of control points 102. Flexible control point connectors can be made out of a variety of materials which can include, but are not limited to spring, strips of elastic, or fiber mesh, for example.

### Rigid Control Point Connectors

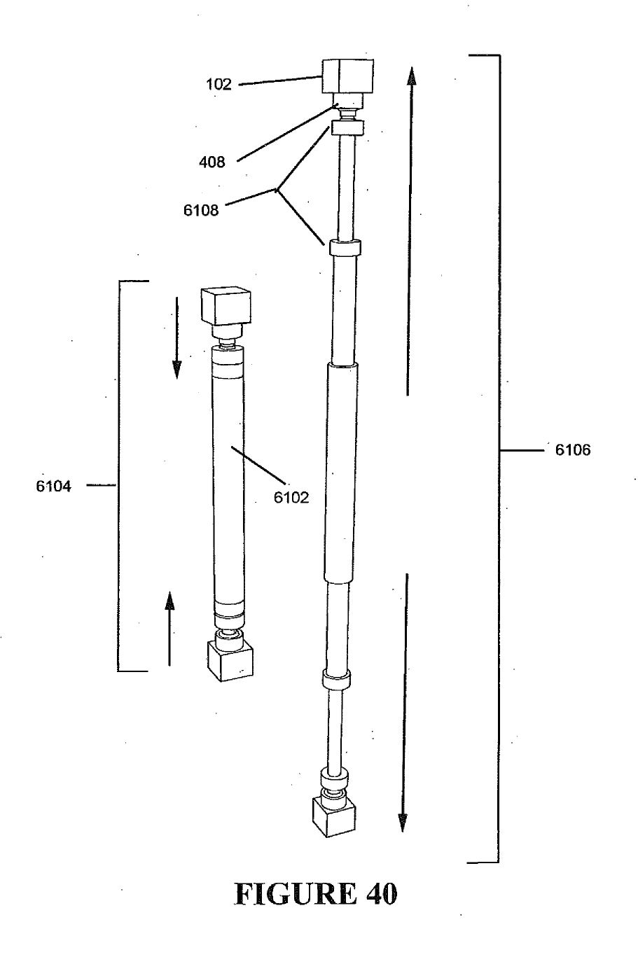

The control point connectors 104 may be rigid components. These rigid connectors are useful when stiff or solid edges are needed. Also, electrical wires, sensors, and data cables can run through these connectors or be attached to the connectors. FIG. 40 illustrates a rigid control point connector in the form of a telescoping tube arrangement 6102. The telescoping tube arrangement 6102 is shown in a retracted configuration 6104 and an expanded configuration 6106. The telescoping tube arrangement 6102 has an outer tubular member 6110, an intermediate tubular member 6112 slidable within the outer tubular member 6110, and an inner tubular member 6114 slidable within the intermediate tubular member 6112.

Alternatively, the rigid control point connector can be made out of various materials which can include but are not limited, expanding or sliding pieces of rigid materials, hollow tubes, shape memory alloy such as Nickel titanium (NiTi) or Nitinol Tubing, Micro coils, Stents, memory wire, and rotational pivots 408, for example.

### Methods to Control Curved Surface Deformations

FIG. 34 is a perspective view of an alternative embodiment curved control point connector 104 that may be used to form and/or control curved surface deformations of the deformable robotic surface. The curved control point connector 104 is suitably connected between two control points 102 in a generally curved manner as shown in FIG. 34. A horizontal actuator 418 extends between the control points 102. When the control points 102 are rotated and/or translated by the actuators, an extendable tube 5404 extends and contracts to create an arch which moves spacers 5402 along the contour of the curved extendable tube 5404. These spacers 5402 act like sliding control points to affect the shape of the control point connectors 104, which affect the deformations of the covering 106 and so on. FIG. 34 shows a curved control point connector that is convex. Alternatively, the curved control point connector may be a concave control point connector.

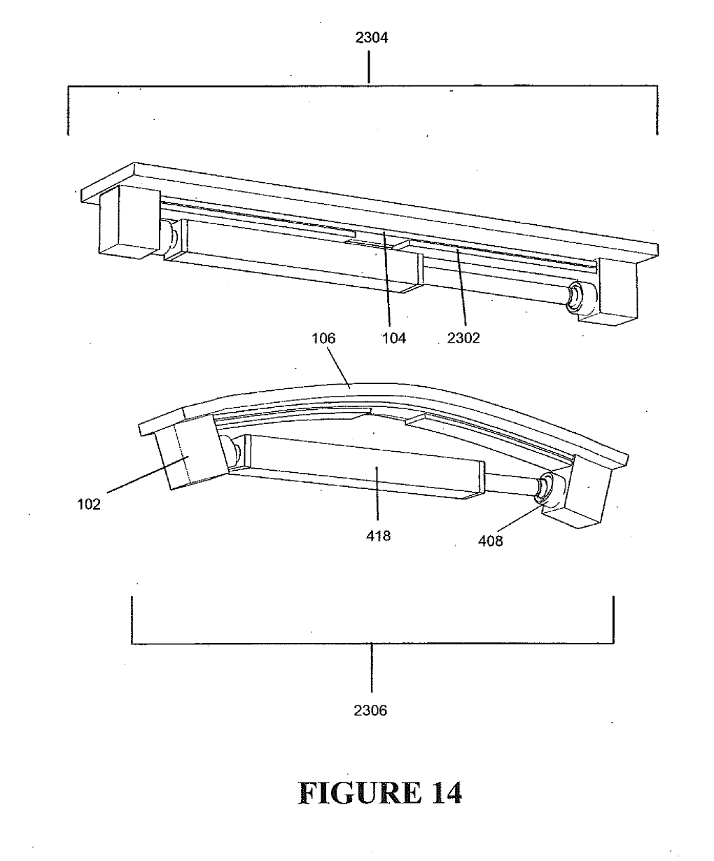

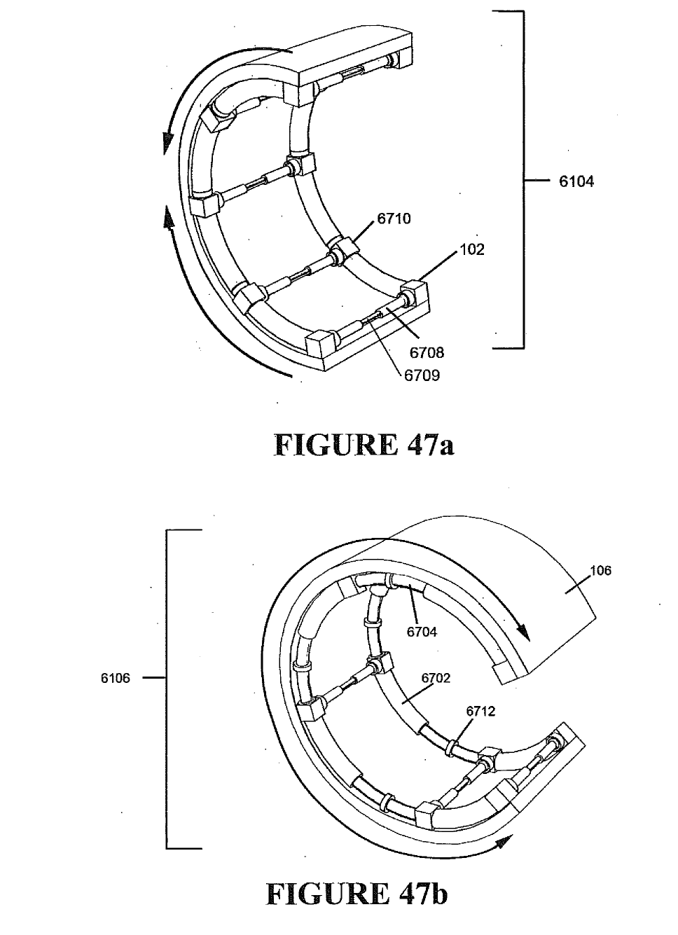

By using curved control point connectors, the number of control points 102 needed to deform a curved surface may be reduced compared to the generally straight connectors described above. When expanded and contracted, these curved connectors create curved edges that support the covering 106 or surface. However, many additional alterations and methods could be applied to create a variety of curved designs. For example, FIG. 47 and FIG. 14 illustrate ways of accomplishing similar curved surfaces.

FIGS. 47a and 47b illustrates an alternative embodiment of the deformable robotic surface having curved rigid control point connectors to create a curved deformable robotic surface. In this embodiment, the control point connectors comprise curved rigid control point connector bases 6702 that are slidably mounted to a rigid control point expander 6704, and straight rigid control point connector bases 6708 that are slidably mounted to a rigid straight control point expander 6709. These components form a curved rigid control point connector cage that is able to contract and expand in the directions shown by the arrows. When actuation is applied to the control points 102, the curved rigid control point connector base 6702 slides along the path determined by the rigid control point expander 6704, which causes the curved rigid control point connector cage to expand from a position similar to that shown in FIG. 47A to a position similar to that shown in FIG. 47B, which moves the covering 106 in a corresponding movement.

Also, a control point connector expander covering support 6712 may be attached to the rigid control point expander 6704 to aid in supporting the surface when the surfaces are expanded. The expander covering support 6712 may be used as a connection point to attach the surface to. Many different combinations of curved and straight control point connectors could be created to make several different shapes.

The curved rigid control point connector connection point 6710 can perform similar functions as a control point. For example, its uses could include, but are not limited to:
as a point to attach the surface to
to attach the aspects of the network in. (sensors, electrical cables, etc.)
as an attachment point for the curved rigid control point connector (tube) base 6702
as an attachment point for the curved control point connector (tube) expander 6704.

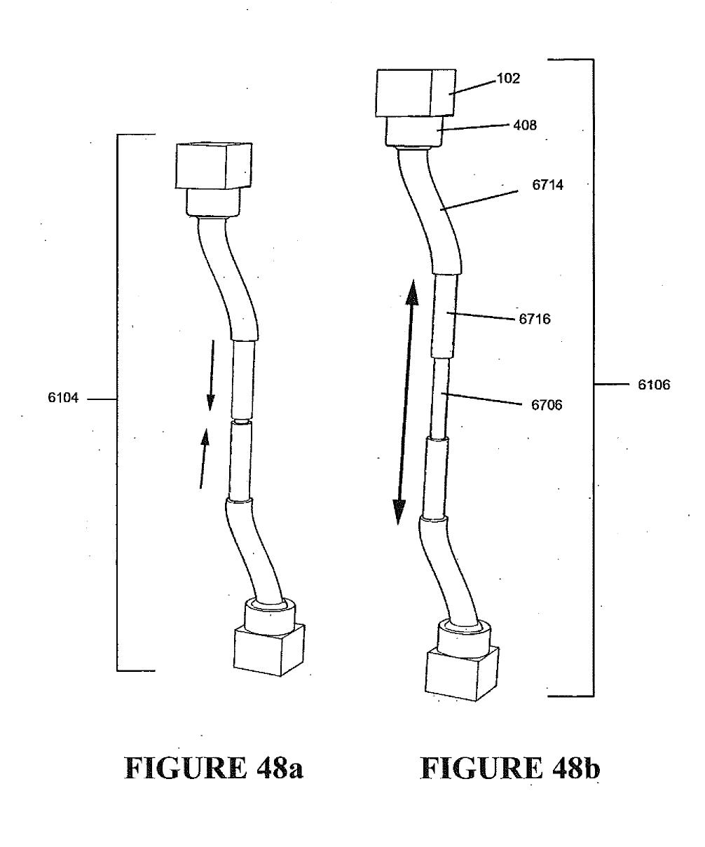

FIG. 48a is a perspective view of alternative curved rigid control point connectors in an unexpanded configuration and FIG. 48b is a perspective view of the curved rigid control point connectors of FIG. 48a in an expanded configuration. This control point connector is a rigid control point connector in the form of a telescoping tube arrangement. The telescoping tube arrangement 6102 is shown in a retracted configuration 6104 and an expanded configuration 6106. The telescoping tube arrangement is similar to the embodiment shown in FIG. 40, except that portions 6714 of the telescopic tube are generally curved.

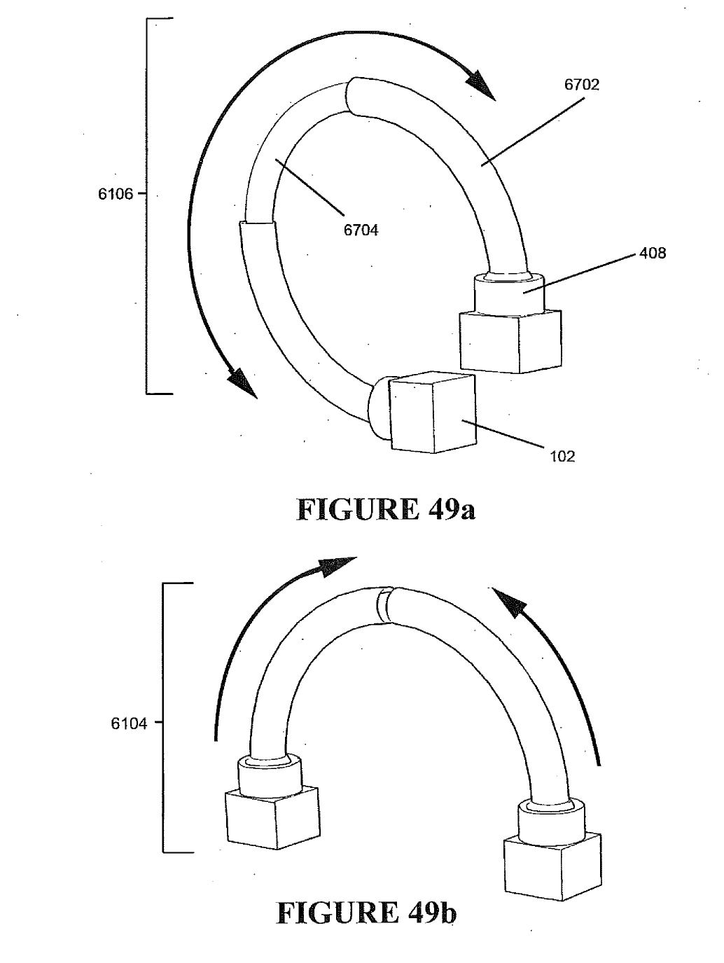

FIG. 49a is a perspective view of a single curved rigid control point connectors in an expanded configuration and FIG. 49b is a perspective view of the curved rigid control point connectors of FIG. 49a in an unexpanded configuration. The curved rigid control point connector is similar to the curved rigid control point connector shown and described in relation to FIGS. 47a and 47b.

FIG. 14 illustrates a method to use flexible supports 2302 to effect the smoothing of the covering from one control point to the next. Each flexible support is attached to a control point 104 and extends towards an adjacent control point 104. The flexible supports comprise a resiliently flexible material. When the control points 102 are actuated, the flexible support 2302 will push against the control point connectors and ultimately deform the covering 106 in a relatively smooth manner. This not only creates a smooth surface on the covering, but also reduces the number of control points 102 needed to manipulate the surface. Reference number 2304 shows the control point connector and flexible support 2302 in a relatively relaxed state and reference number 2306 shows the control point connector and flexible support 2302 in a relatively deformed or bent state. Many types flexible or resilient materials can be used, which can include, but are not limited to: plastics, metals, rubber, for example.

### Actuating Control Point Connectors

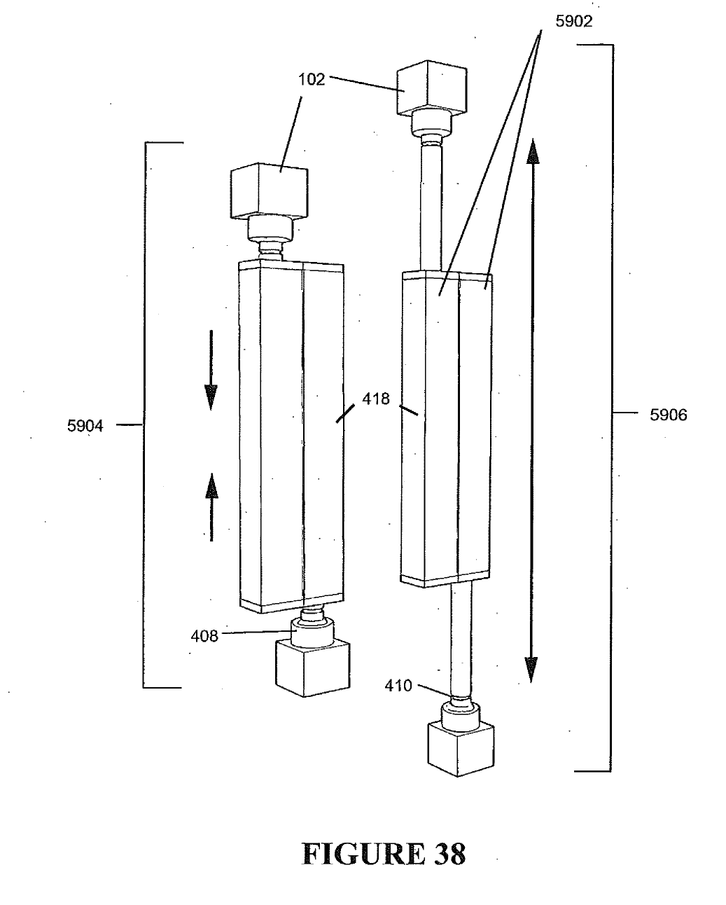

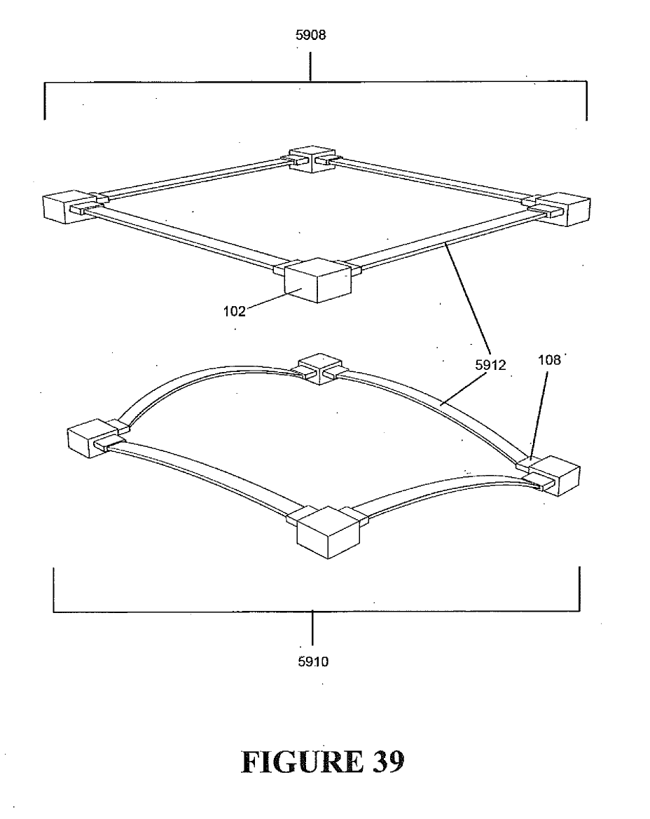

FIGS. 38 and 39 show two alternative embodiment control point connectors. In these alternative embodiments, the control point connectors comprise actuators. These actuating control point connectors can deform the deformable robotic surface without any additional actuation system or they can be used with other actuation systems to aid with the deformations. In the following, there are two example methods that this could be done. However, there are many other methods that could be used to create used to create actuating control point connectors.

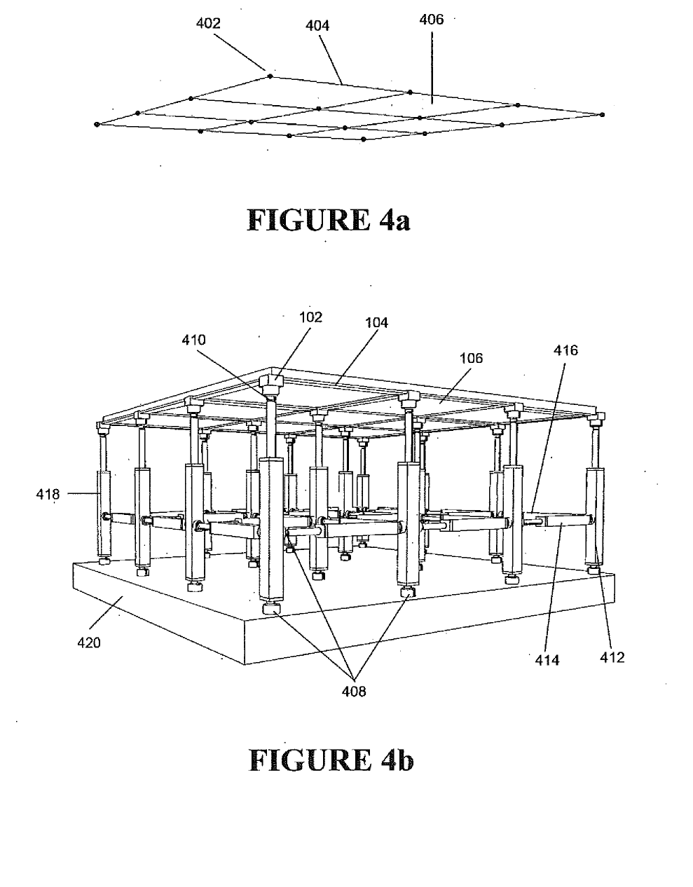

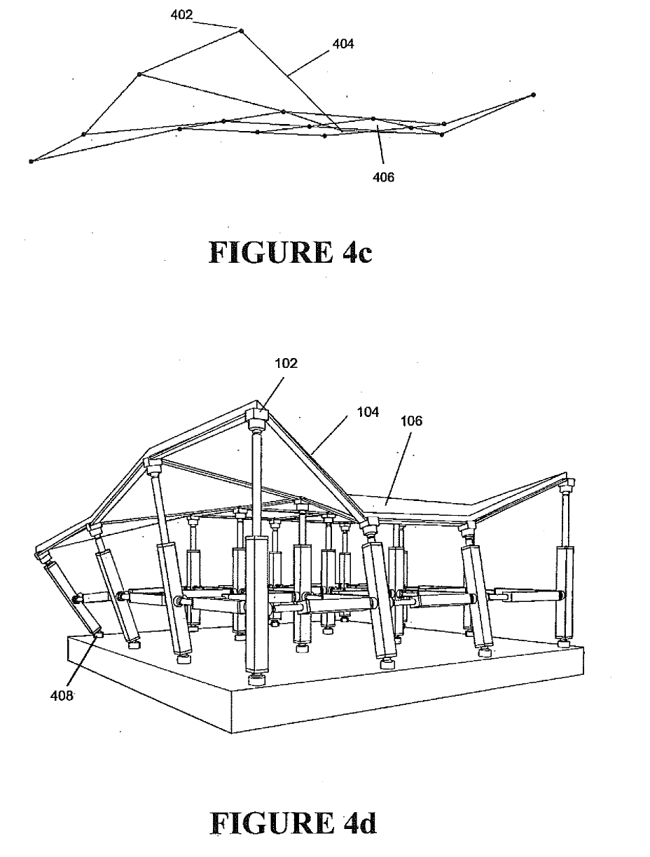

FIG. 38 illustrates a view of an actuating control point connector extending between a control point 102 and a rotational pivot 408. The rotational pivot 408 is described above in relation to FIG. 4. The actuators 418 are preferably telescopic actuators that are adapted to create linear movement of the control points 102. Reference number 5904 indicates an actuator 418 in a relaxed configuration and reference number 5906 indicates the actuator in a deformed configuration. Therefore, the connector is the actuation system moving the attached control points 102 to the correct point in space. Also, two or more actuators 418 can be bound together to create more movement than a single, when desired.

FIG. 39 illustrates an embodiment in which the control point connectors 5912 comprises electroactive polymers that are used to actuate the control points 102. Electroactive polymers expand when voltage is applied. These electroactive polymer control point connectors can be very useful to create curved surfaces and surface supports as well, since the electroactive polymers can deform in more organic ways than other actuators. This is clear when you compare the non-actuated control point connector 5908 and the actuated control point connector 5910 with voltage applied.

### Expanding and Contracting Web

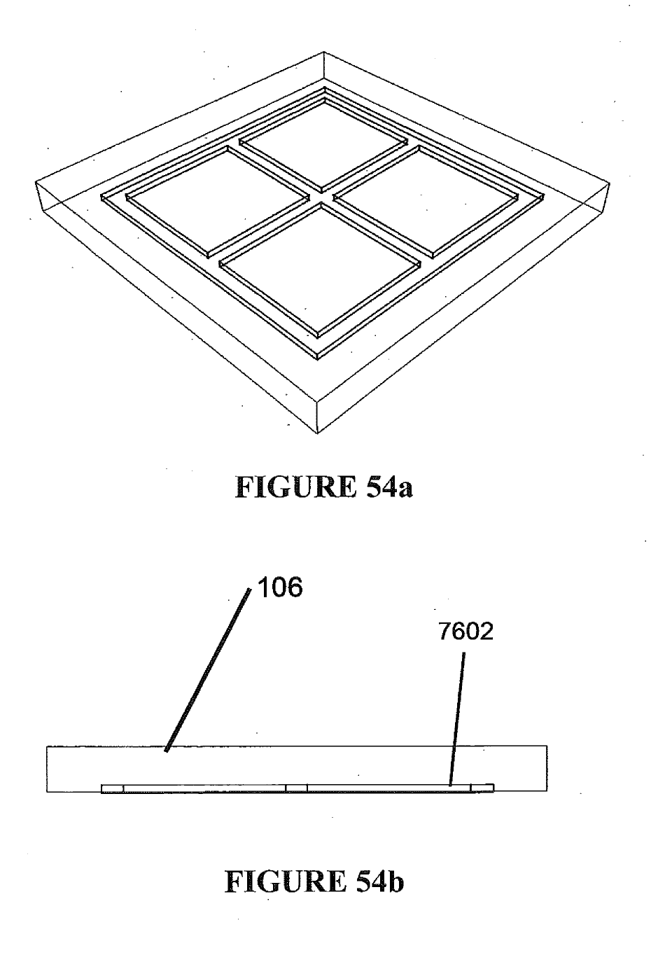

FIG. 54 shows an expanding and contracting web. The expanding and contracting web 7602, is an expandable and/or contracting surface which is designed in web or grid patterns. The expanding and contracting web comprises control points and control point connectors that are integrally connected together to form a web. Since the expanding and contracting web can be designed as one continuous webbed mesh or as a modular system, separate control points 102 are not needed to connect them together. The expanding and contracting web 7602 can be created using many of the same materials and methods that the separate control point connectors 104 are created from, as described above. The expanding and contracting web 7602, can also perform the same functions of the control points 102 and the control point connectors 104. There are several other ways that the expanding and contracting web 7602 could be designed, which can include, but are not limited to: elastic net, a web of electroactive polymers, fiber mesh, rubber net, or an inter locking web of springs, for example.

### Covering

In the preferred embodiment, a covering 106 is attached to the control points 102 and the control point connectors 104 to create an external surface or covering of the deformable robotic surface. In the preferred embodiment shown in FIG. 1, the covering is a generally planar component, which is suitably deformable so that as the control points and/or control point connectors move, a corresponding portion of the covering will also move. In an alternative embodiments, the covering may be a generally curved or non-plan component. In these alternative embodiments, the covering is also suitably deformable so that as the control points and/or control point connectors move, a corresponding portion of the covering will also move.

The covering is preferably a unitary component. Alternatively, the covering may be formed by one or more pieces of covering.

The covering 106 may be used:
to transfer data and energy
as a surface used to attach or embed sensors to
as a surface to embed control points and control point connectors into
to distribute the actuation from the control points 102 and/or the control point connectors 106 to an exterior surface
as a method to support the exterior surface 704 and the additional layer 702.

The covering may be formed from a stretchable, elastic, or resilient material so that it stretches as the control points and control point connectors move. In an alternative embodiment, the covering may be formed from a flexible material so that it flexes as the control points and control point connectors move. In a further alternative embodiment, the covering may comprise a substantially non-stretch material. The covering 106 can be made out of a variety of materials which can include, but is not limited to rubber, elastic fibers, spandex, nylon, polyesters, silicon, latex, polyurethanes, metal fibers, mesh fibers, springs, and sliding metal plates, for example.

The best method to adhere the covering 106 to the control points 102 and control point connectors 106 or the expanding and contracting web 7602 can be determined by, but is not limited to: the materials that being attached, the desired range of motion, desired elasticity, and compatibility of the adhesion with the surfaces that are being attached.

Products that could attach the surfaces together could be, but should not be limited to, super glue, epoxies, hook and loop fasteners, elastomer adhesives, other suitable adhesives, for example.

### Printing the Control Point, Control Point Connector, Expanding and Contracting Web Layout on a Covering

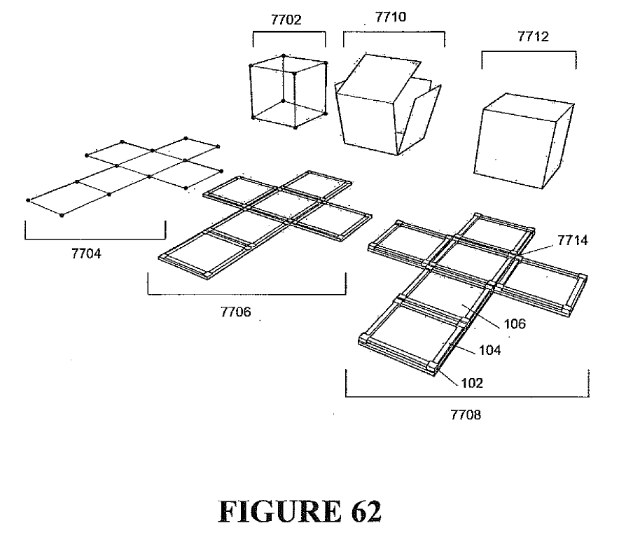

As illustrated in FIG. 62, the locations of the control points 102 and control point connectors 104 (or expanding and contracting web 7602) can be printed onto the covering 106 of the robotic surface, thus, creating a physical blueprint of where the control points 102 and the control point connectors 104 should be on the robotic surface. This can be done by creating the desired deformable robotic surface in a 3D computer program 7702 that corresponds to that of the superficial robotic surface design. Once this 3d geometry has been created, the 3d geometry can be unwrapped to create a flat plane in the 3d application 7704. When unwrapping the 3d surface, it is a preferable to respect the relative distance between the vertices 402 and edges 404. Once an unwrapped surface has been created, and an image of the predicted locations of the control points 102 and the control point connectors 104 can be made, and then this image can be printed on to the covering 7706. This printed covering 106 can serve as a template in which the control points 102 and control point connectors 104 can be attached to, as seen in 7708.

FIG. 62 shows that the control points 102 are attached by hinge joints 7714, so that the robotic surface can be deformed back into its intended superficial form. The drawings illustrate this in two reference numbers, the partially assembled robotic surface 7710 and the fully assembled robotic surface 7712. This technique can also be applied to the additional layer 702 or the exterior surface 704.

### Actuating Surface Supports

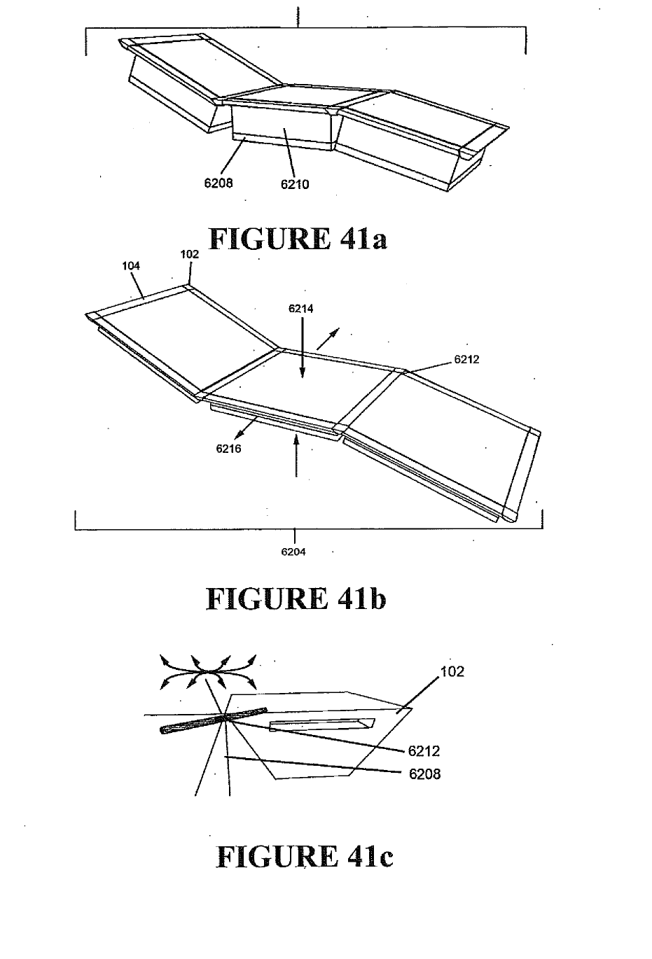

FIG. 41a is a perspective view of a preferred embodiment actuating surface support 6202 in a relaxed state. This actuating surface support can be created using electro active polymers. The support surface has portions of dielectric elastomer film 6210. When voltage is applied, the electro active polymers expand 6204, which moves the control points 102 to new locations, shown in FIG. 41b. Reference number 6214 indicates a thickness contraction and reference number indicates an area expansion 6216. These electro active polymers can reduce the number of the other actuators needed to create the deformation since the polymer is an actuator itself. Also, the polymer can act as a rigid backing to the surface to give additional support. Alternatively, these electroactive polymers could be used to create curved surfaces.

FIG. 41c illustrates how the control point 102 can be attached to the electroactive polymer via an embedded bendable wire connector 6212. This embedded bendable wire connector 6212 can bend with many degrees of freedom (indicated by the arrows in FIG. 41c) to keep the two parts attached together and still provide a reasonable range of motion between the two objects. Many alternative methods to attach these two points could be used, which may include but are not limited to an embedded chain, a rotational pivot, embedded flexible plastics, embedded rubber strips, for example.

### Control Points and Control Point Connectors Forming a Network

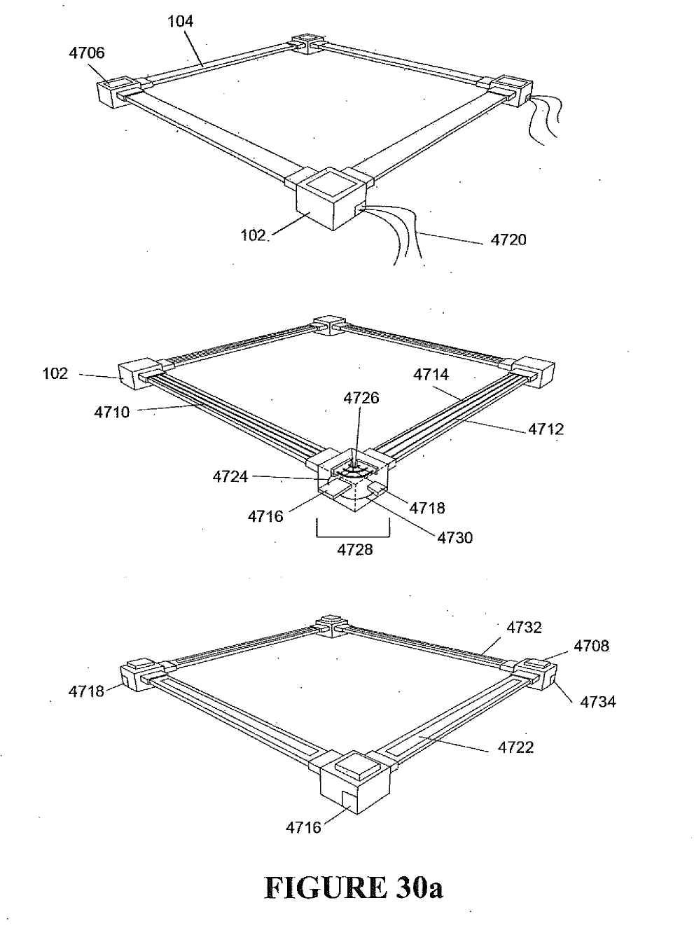

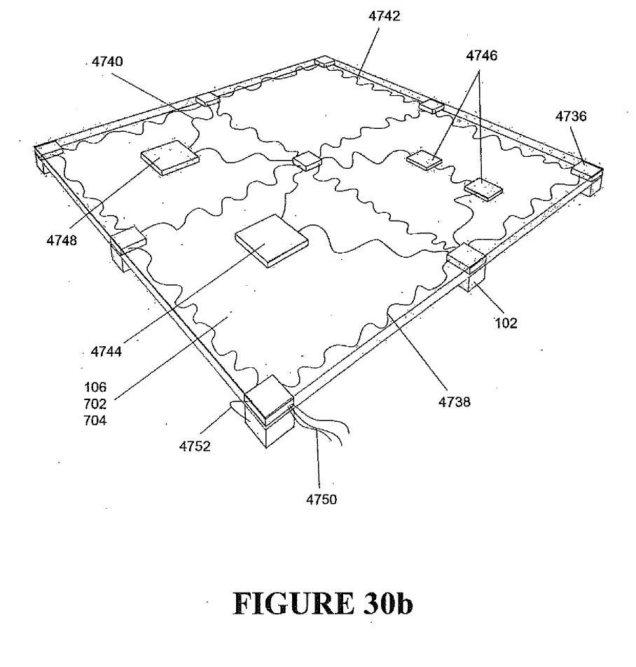

FIGS. 30 and 30b, illustrates that electrical wires, data transfer wires, sensors, transmitters and various electrical components and devices can be attached to or embedded into a networked web of control points 102 and control point connectors 104 (or an expanding and contracting web 7602) to relay energy, transfer data, transfer actuation, and attach sensors throughout the deformable robotic surface and to the rest of the robot. The covering 106, the additional surface 702 and the exterior surface 704 can also contain this functionality as well.

These networked capabilities could include, but are not limited to:
sensors embedded into control point 4706
sensors attached to control point 4708
electrical wiring embedded in to control point connector 4710
data transfer wires embedded into the control point connector 4712
Actuation transfer tubes, which transfer hydraulic fluids, air through the control point connector 4714
micro processors 4716 which can be attached to the exterior or embedded into the interior of the control point 102
transmitters and receivers 4718 which can be attached to the exterior or embedded into the interior of the control point 102
wiring that can be used to connect the deformable robotic surface to the rest of the robot 4720
sensors attached to control point connectors 4722
Wiring connecting the control point connector end to a processor 4724
Wiring connecting the network from one control point connector to another inside of a control point 4726
wiring connecting the transmitter/receiver to the micro processor 4730
An internal view of a control point 4728
various electrical components embedded into or attached to a control point connector 4732
various electrical components embedded into or attached to a control point 4734

FIG. 30b, illustrates an embodiment in which electrical wires, data transfer wires, sensors and transmitters, and various other electronic components are attached to or embedded into a covering to relay energy, transfer data, transfer actuation, and/or attach sensors throughout the robotic surface and to the rest of the robot. Additionally or alternatively, the additional surface 702 and the exterior surface 704 may contain this functionality as well. Various combinations of these components and additional components may be used to create various robotic surfaces. These networked capabilities can include, but are not limited to the following examples:
sensors embedded into or attached to a covering 4730
electrical wiring embedded into or attached to a covering 4732
data transfer wires embedded into or attached to a covering 4734
Actuation transfer tubes, which transfer hydraulic fluids, air through the control point connector 4736
micro processor embedded into or attached to a covering 4738
transmitters and receivers embedded into or attached to a covering 4740
various electrical components embedded into or attached to the covering 4742
wiring used to connect covering to the rest of the robot 4742
Wiring connecting the covering's sensors to the control point 4744

### Deformable Robotic Surface Combinations

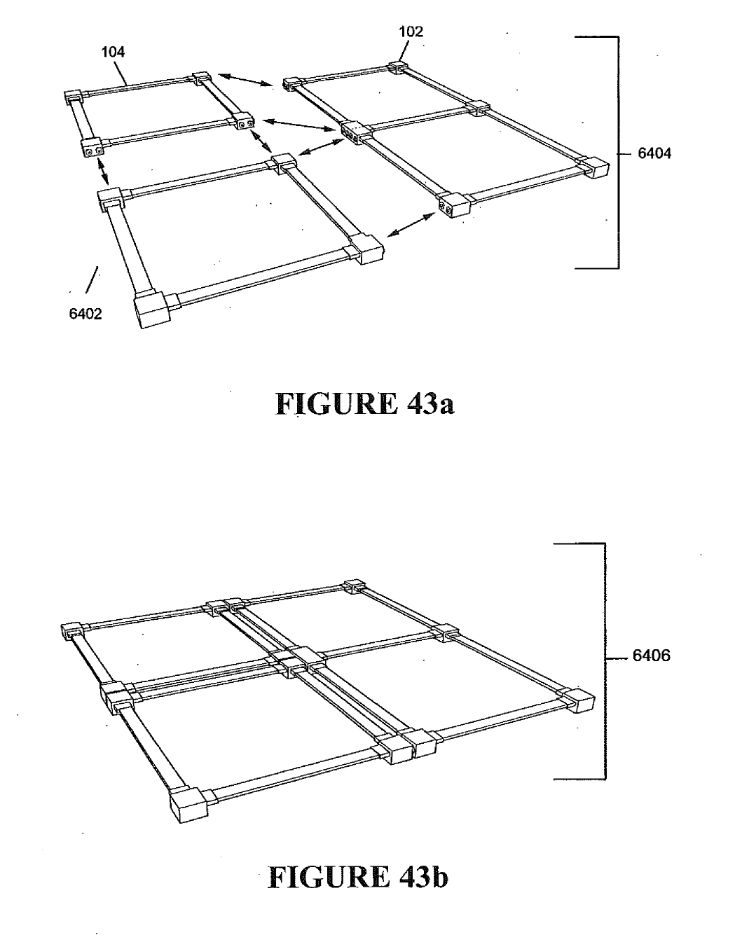

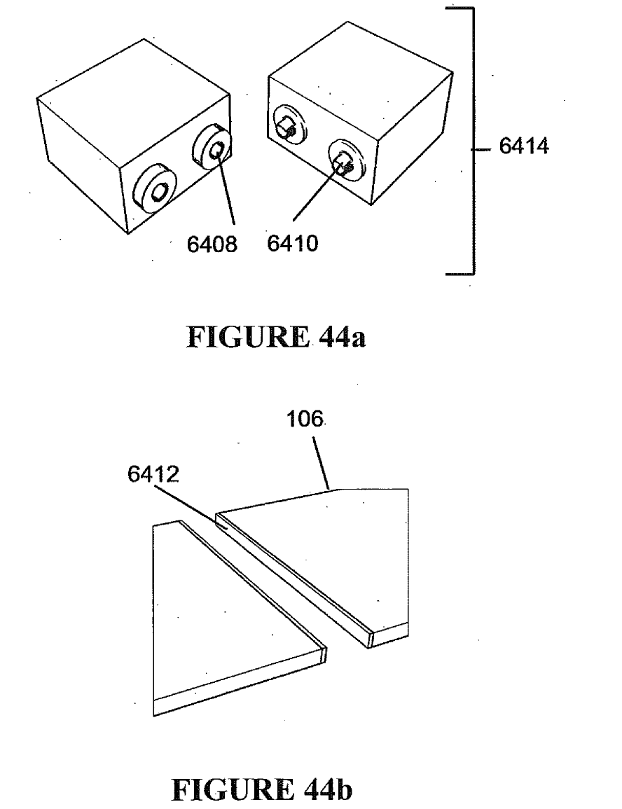

FIGS. 43A and 43B show combinations of preferred embodiment deformable robotic surfaces. A deformable robotic surface can be created from individual linking deformable robotic surface polygons 6402 and/or strips of linking deformable robotic surface polygons 6404. In addition, the deformable robotic surface can be created as one continuous suit as well. These individual linking deformable robotic surface polygons 6402 and/or strips of linking deformable robotic surface polygons 6404 can be attached and detached, to create new and unique combinations of deformable robotic surface, which can create various new surfaces 6406. Since these individual parts can be added and then removed, it enables one to quickly test and tune the internal workings of the actuation system and then reattach these independent parts to the rest of the deformable robotic surface.

In the embodiment shown, the individual linking deformable robotic surface polygons 6402 and/or strips of linking deformable robotic surface polygons 6404 have locking control points 6414. The locking control points are preferably spaced along the edges of the individual deformable robotic surface parts. The locking control points have corresponding snap fasteners to combine these independent parts or the locking control point 6414 together. For example, 6408 and 6410 illustrates that the male and female ends of snap fasteners can be used to snap these locking control points 6414 together. These locking control points 6414 can be made from a variety of materials, utilizing various techniques to lock them together, which can include but is not limited to magnetic attachment ends, a variety of metal and plastic fasteners, or interlocking clips, for example.

In addition, the individual parts also have re-attachable edges 6412 on the covering 106 or on the control point connector 104. These re-attachable edges of the deformable robotic surface can be made out of a variety of different materials which can include, but are not limited to, hook and loop fasteners, strips of adhesive material, stitching, adhesives, or slide fasteners for example.

### Density of Control Points and Control Point Connectors

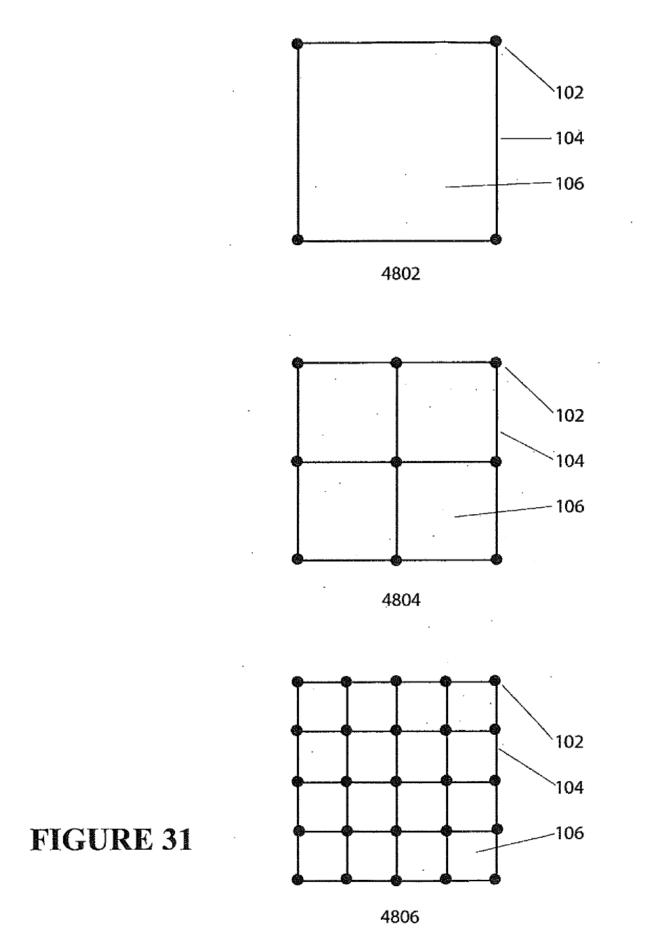

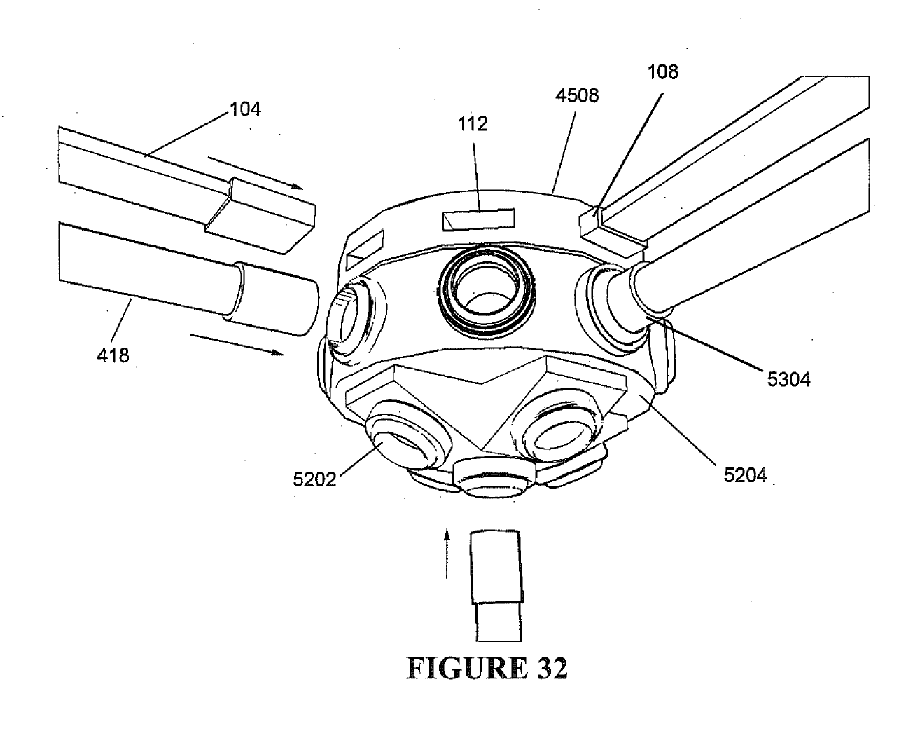

FIG. 31 illustrates that a low 4802, medium 4804, and high density 4806 control point 102 layouts can be used to describe the same surface. In general, the highest density possible is preferred because it provides a higher level of detail. In most cases, the higher the density of control points 102 on the deformable robotic surface the more specific deformations that can be made on surface since there are more points to manipulate the surface with. However, the actuation system used to actuate the deformable robotic surface with can be a huge factor in determining the control point 102 density needed or possible, since the actuation system may or may not have enough detail in the actuation to move the control points 102 to the desired positions. In situations like these, less control points 102 are more practical for the application. Factors which may determine the preferred density of the control points 102 may include but are not limited to the actuation system being used, the size of control points 102, and the space available, for example.

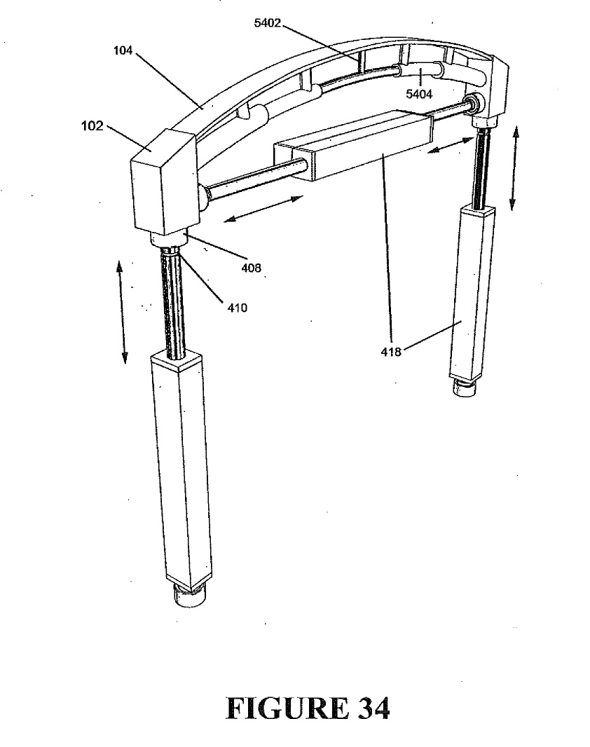

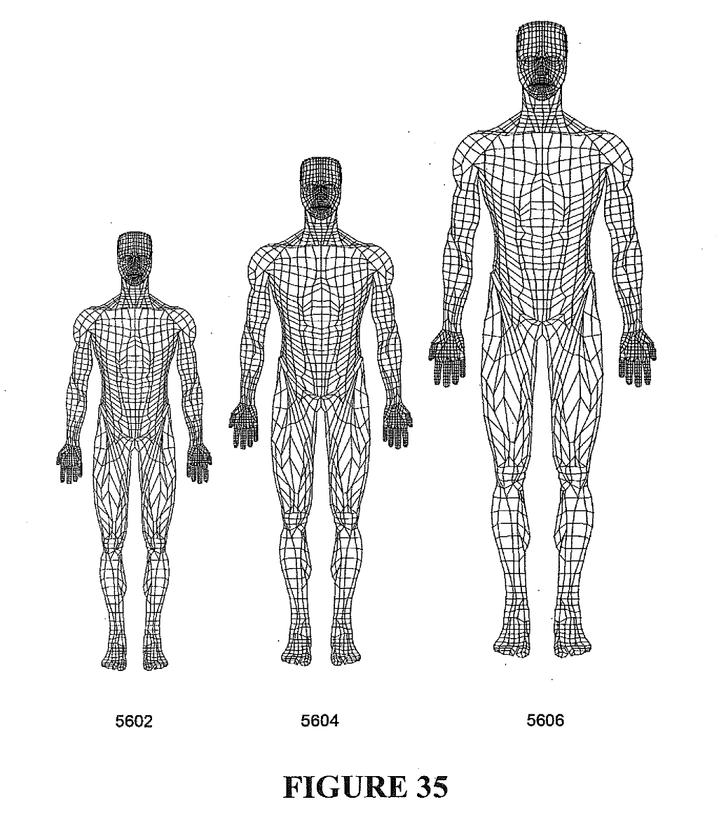

Since the computer is capable of designing objects that are extremely small and/or extremely large, creating a deformable robotic surface that matches the scale of the object in the computer may not always be possible. However, if the computerized scale of the objects surface cannot be created in the physical world, alternative scales can be used to create an object that deforms “relatively” proportionately the same. FIG. 35 illustrates three different scales applied to the deformable robotic surface, the actual scale 5604, a smaller scale 5602, and a larger scale 5606. Various other scales can be applied to the same deformable robotic surface.

### Actuation Systems

An actuation system that is used to deform a deformable robotic surface can also be referred to as an artificial muscle system. The deformable robotic surface's adaptability to multiple actuation/artificial muscles systems is a flexible aspect of its design. Almost any actuation system can be used to deform a deformable robotic surface, as long as the control points 102 can be actuated to the proper space in time, throughout the range of motion desired. The actuation systems used to the drive the deformable robotic surface could include, but is not limited to: pneumatic actuation, electro active polymers actuation, hydraulic actuation, magnetic actuation, mechanical actuation, piezoelectric actuation, electro-mechanical actuation, and fiber reinforced rubber actuators driven hydraulically or pneumatically, for example. The following list the preferred actuation method and two alternative actuation methods to demonstrate the flexibility of the deformable robotic surface to adapt to multiple types of actuation/artificial muscle systems.

### Preferred Artificial Muscle System

FIG. 4a is a three-dimensional computer representation of the deformable robotic surface. FIG. 4a shows the computer representation in a neutral or undeformed state. The computer representation shows polygons having vertices 402, edges 404 and faces 406. The vertices 402, edges 404 and faces 406 are components that describe polygons in 3d computer applications. The control points 102, control point connectors 104 and the covering 106 of the deformable robotic surface can be represented in 3D programs as vertices 402, edges 404 and faces 406. The following illustrates this correlation:

(A) the control point 102 is represented as a vertex 402
(B) the control point connector 104 is represented as an edge 404
(C) the covering 106 is represented as a face or series of faces 406.

FIG. 4b shows a deformable robotic surface corresponding to the three-dimensional computer representation shown in FIG. 4a. FIG. 4b shows the deformable robotic surface in a neutral or undeformed state.

The deformable robotic surface shown in FIG. 4b has a rotational bearing 410 between the actuator and the control point 102. The deformable robotic surface has actuators for controlling movement on the y axis 412, actuators for controlling movement on the x axis 414, and actuators for controlling movement on the z axis 416. The reference numeral 418 is used throughout the specification to refer to an actuator in a generic sense. The actuators are mounted to a base 420 via rotational pivots 408.

FIG. 4c shows the three-dimensional computer representation of FIG. 4a in a deformed state. FIG. 4d shows deformable robotic surface in a corresponding state in which selected control points are translated to a required position.

FIG. 4b and FIG. 4d illustrate a preferred method to actuate the control points 102 of this deformable robotic surface. In this embodiment, each of the control points 102 are attached to a corresponding actuator. These actuators position a control point 102 by translating the x, y, and z directions of a point to move the individual control points 102 to specific locations in space and time. When properly executed, these control points 102 can mimic the corresponding vertex positions of the 3D computer model as shown in FIG. 4a and FIG. 4c.

### Rotational Pivot Points

Each actuators is preferably attached to a support surface 420 via a rotational pivot. FIGS. 4a to 4d show rotation pivots in the form of uniball bearings 408. These rotational pivots 408 allow the actuators to remain connected to an object and rotate when linear actuation from multiple actuators are pushing and pulling on each other. It is not necessary for the rotational pivots 408 to have rotational actuator since they will automatically respond to the actuation of the linear actuators when the connected actuators move. However, if desired rotational actuators could be used instead of the rotational pivot.

Various types of rotational pivots could be used, as long as the appropriate degrees of freedom can be achieved. The rotational pivot can be made by various methods, which can include, but are not limited to rod bearings, multiple rotational hinges, for example.

FIG. 4a-FIG. 4d illustrates a method in which a deformable robotic surface can be used to recreate 3d animated surfaces in the physical world. This can be accomplished by recording the distance traveled by the vertex 402 of the computer representation throughout space and time. Then the same space and time are matched on the corresponding control points 102 via the actuation. Therefore, almost any animated or non-animated surface that is designed in a 3D computer application can be re-created in the real world, exceptions can include, but are not limited to: size, control points, connectors, etc. occupying the same physical space, animated surface that deform through each other.

### Alternative Actuation Methods

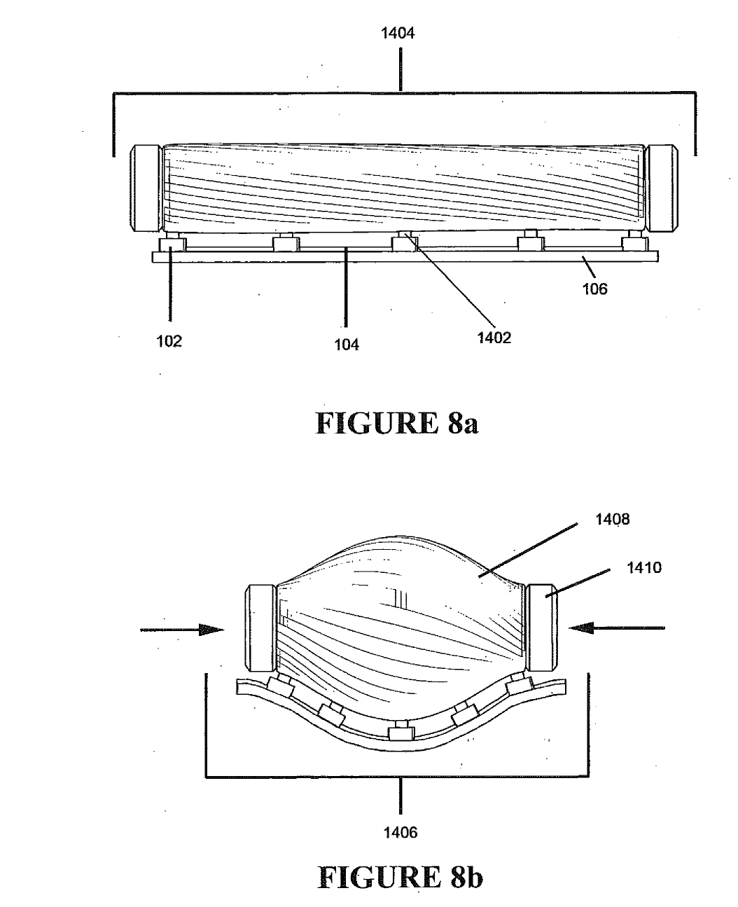

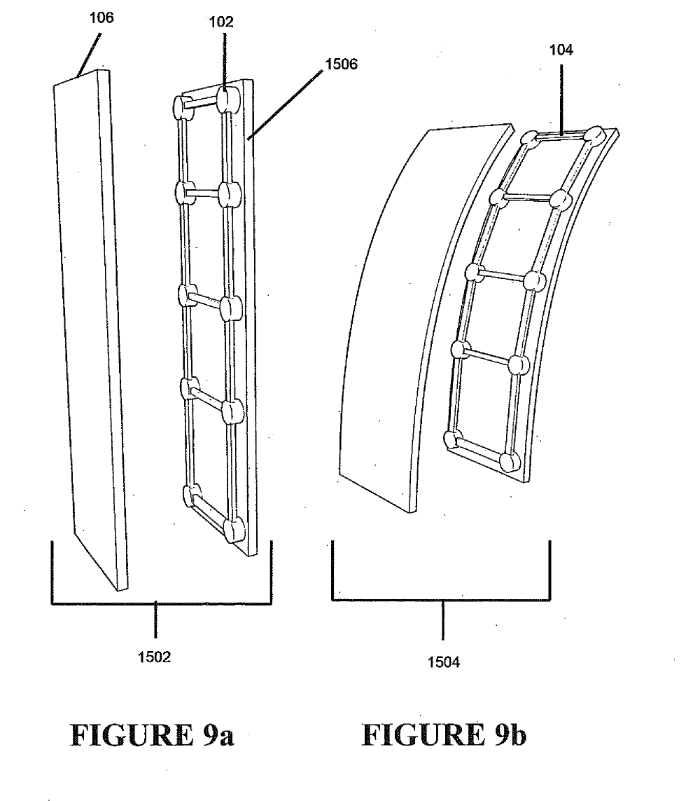

FIGS. 8a and 8b, and FIGS. 9a and 9b illustrate alternative actuation systems for deforming the deformable robotic surface.

FIG. 8b shows a pneumatic actuator having a bladder 1408 in an inflated configuration and FIG. 8a shows the pneumatic actuator in a deflated configuration. The bladder comprises an actuator membrane 1408. The control points 102 are attached to the pneumatic actuator 1404 via control point bases 1402. The pneumatic actuators actuate the control points 102. For example, the change in position is shown by comparing the deflated actuator in 1404 to the inflated actuator in 1406. The actuator clearly moves the control points 102 to new positions in space. Pneumatic actuators may be used in many other ways to manipulate the position of the control points. For example the control points may be attached to the ends of actuators or run in irregular patterns across the bladder surface. Alternatively, this design may be created without the control point base 1402 by adhering the control point directly to the actuation bladder 1408.

FIGS. 9a and 9b show an actuator in the form of an electroactive polymer 1506. In this alternative embodiment, the control points 102 and control point connectors 104 are connected to the electroactive polymer 1506. When a voltage is applied to the electroactive polymer, the electroactive polymer will change position. The change in position is shown by comparing the actuator with the voltage off, indicated by reference number 1502 to the actuator with voltage on, indicated by reference number 1504. The actuator moves the control points 102 to the new positions in space, since the control points 102 are connected to the actuator. Electroactive polymer actuators can be used in many other ways to manipulate the position of the control points as well. For example, the electroactive polymers may be designed to mimic the flow of an organism muscle structure to which, control points can be attached to. The electroactive polymers can be created in curved, flat, or coiled shapes, for example, to which control points may be attached to.

### Actuation/Control Point Binders

For the deformable robotic surface to be actuated by various actuation systems, sometimes it is necessary to change the binders, fasteners and connectors 1402 that bind the actuation system to the deformable robotic surface. Various binders, fasteners, and connectors 1402 may be used since the design is largely dependent on the type of control point and actuation system used. Preferably, the actuation system may be attached directly to the control points.

### Flexible Bases

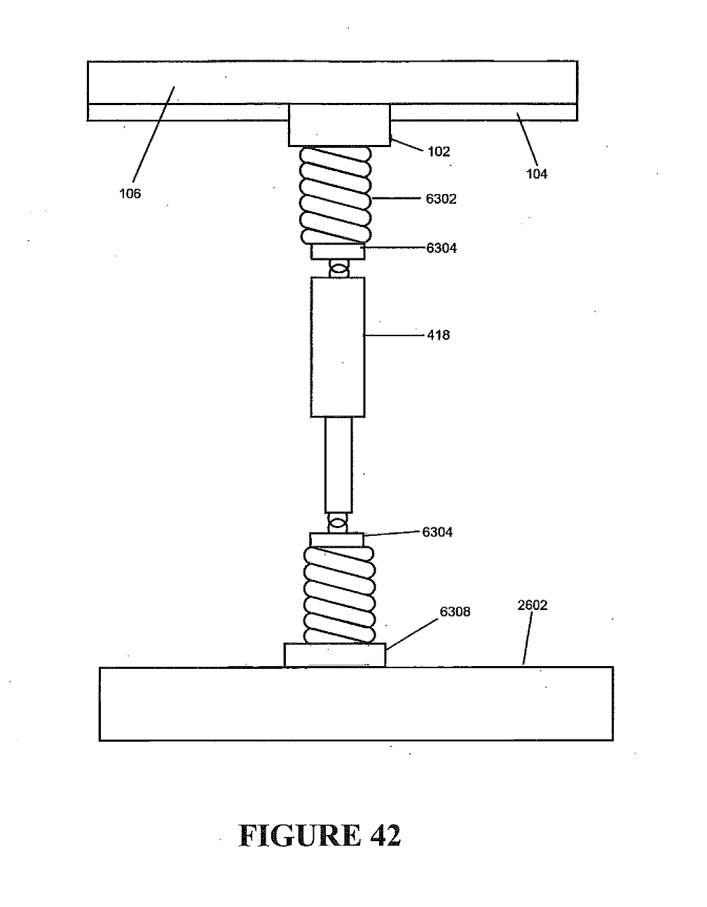

Flexible bases 6302 can be added to the actuation system to act as shock absorbers for the actuation system. FIG. 42 shows a preferred embodiment flexible base attached to each end of an actuator 418. The flexible bases are preferably attached between the actuator 418 and the cover 106, control point connector 104, and the control point 102. The flexible bases have a spring 6302, a spring to actuator connector 6304, and a spring to base connector 6308.

FIG. 42 shows two flexible bases, with one flexible base attached at each end of the actuator. Alternatively, the actuator may be rigidly attached at one end, and flexibly attached via a flexible base at the other end.

The flexible bases may be attached to one or more of the actuators of the deformable robotic surface. Alternatively, the flexible bases may be attached to only some of the actuators of the deformable robotic surface.

These flexible bases can cushion impacts that are created from external forces, which could potentially break the actuation system. These flexible bases can be made out of a variety of materials, which can include, but should not be limited to: springs, rubber, silicon, plastic, for example.

Blending the Deformable Robotic Surface with Non-Deformable Robotic Surface Parts

The robotic surface may be attached to a non-deformable robotic surface and/or be attached to additional layers or artificial skins, for example.

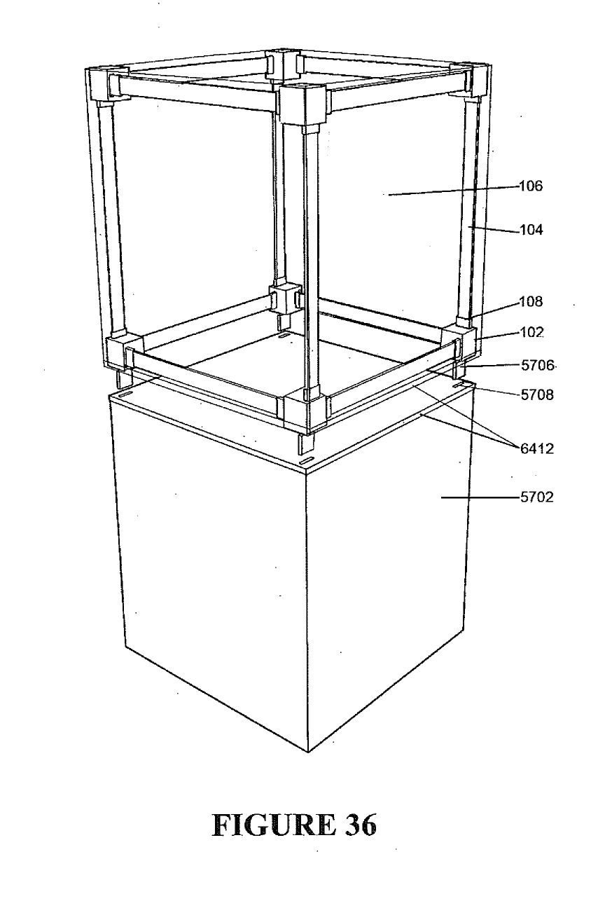

FIG. 36 illustrates a method to attach a deformable robotic surface to a non-robotic surface 5702. A male connector 5706 which is securable to the control point 102, is also insertable and securable into the non-robotic surface's female connection slot 5708. In addition, a re-attachable edge 6412 can be added to the edge of the non-robotic surface 5702 and the deformable robotic surface to attach the edge of deformable robotic surface to the edge of the non-robotic surface 5702. The deformable robotic surface can be attached to the non-robotic surface 5702 in many other ways as well, which can include but is not limited to: super glue, epoxies, hook and loop fasteners, elastomer adhesives, slide fasteners, other adhesives, artificial skin, with one or more additional layers, and with attachments, for example.

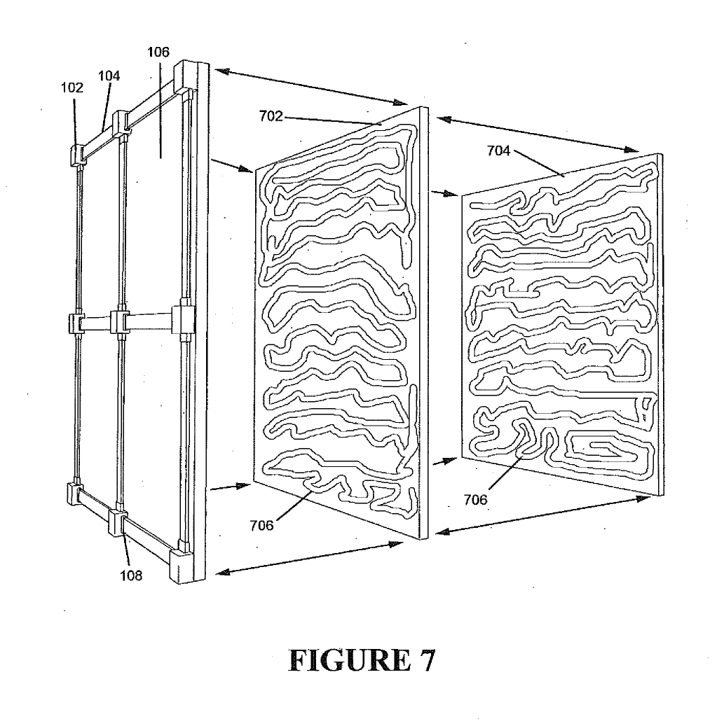

FIG. 7 is perspective view of the preferred embodiment deformable robotic surface of FIG. 1 with additional layers or artificial skins. The additional layers or artificial skins are suitably deformable so that they may deform as covering layer, control points, and control point connectors deform. FIG. 7 shows an additional layer 702 and/or artificial skin/exterior surface 704 that are attachable to the deformable robotic surface. An artificial skin/exterior surface 704 may be added to the deformable robotic surface to create additional surface details. This exterior surface 704 can be created artificially, or it could be cloned from an organism and added as a superficial covering to the deformable robotic surface. The exterior surface 704 can be created by a variety of molded and non-molded materials, which can include, but are not limited to: Silicon, prosthetic skin, Frubber by David Hanson, special effects skin materials, and dragon skin, for example.

In the preferred embodiment shown in FIG. 7, the further additional layer 702 may be added between the covering 106 and the exterior surface 704. Additionally or alternatively, the additional layer 702 may be placed below the deformable robotic surface. This additional layer 702 can be used to create a variety of different effects, which can include, but are not limited to: a fat layer (silicon, rubber, fluid), an additional actuation layer, a network for sensors, wires, and other associated components, and/or as a material to alter the feel of the surface, for example.

The exterior surface 704 and/or the additional layer 702 is preferably bonded to the deformable robotic surface using an adhesive 706 or a wide variety of other materials which can attach these surfaces together. The best method to adhere these surfaces together can be determined by, but is not limited to: the materials that being attached, the desired range of motion, desired elasticity, compatibility of the adhesion with the surfaces that are being attached, products that could attach the surfaces together could be, but should not be limited to: super glue, epoxies, hook and loop fasteners, elastomer adhesives, other adhesives, for example.

### Alternative Deformable Robotic Surface Combinations

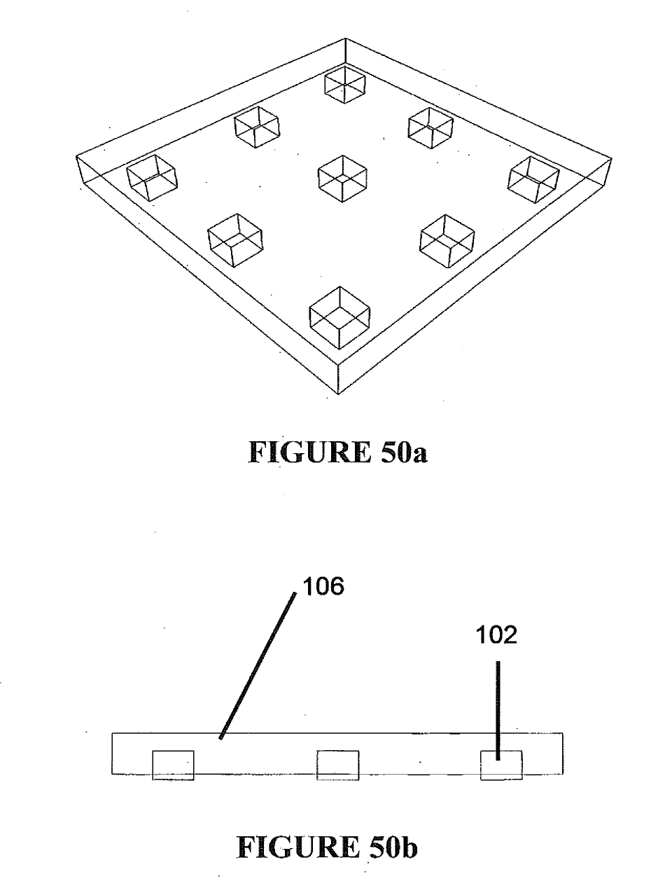

FIGS. 50a to 61b show alternative embodiment of the deformable robotic surface. Unless described below, the features and operation should be considered to be the same as those described above in relation and like numerals are used to indicate like parts. The alternative embodiments can include, but are not limited to:

FIGS. 50a and 50b illustrates an alternative embodiment in which control points 102 are embedded into a covering 106. Alternatively, the control points 102 may be embedded into the additional layer 702, or the exterior surface 704. In this alternative embodiment, the control points are substantially flush with a lower surface of the covering.

FIGS. 51a and 51b illustrates an alternative embodiment in which control points 102 are attached to a covering 106. Alternatively, the control points 102 may be attached to the additional layer 702 or exterior surface 704. In this alternative embodiment, the control points are attached to a lower surface of the covering and extend away from the covering.

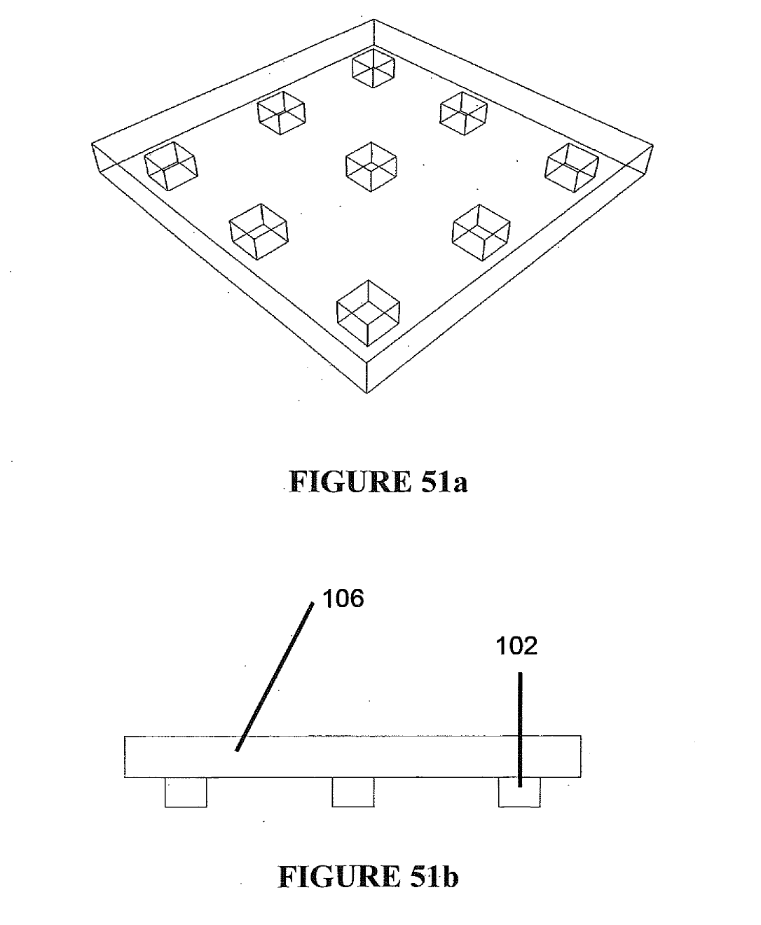

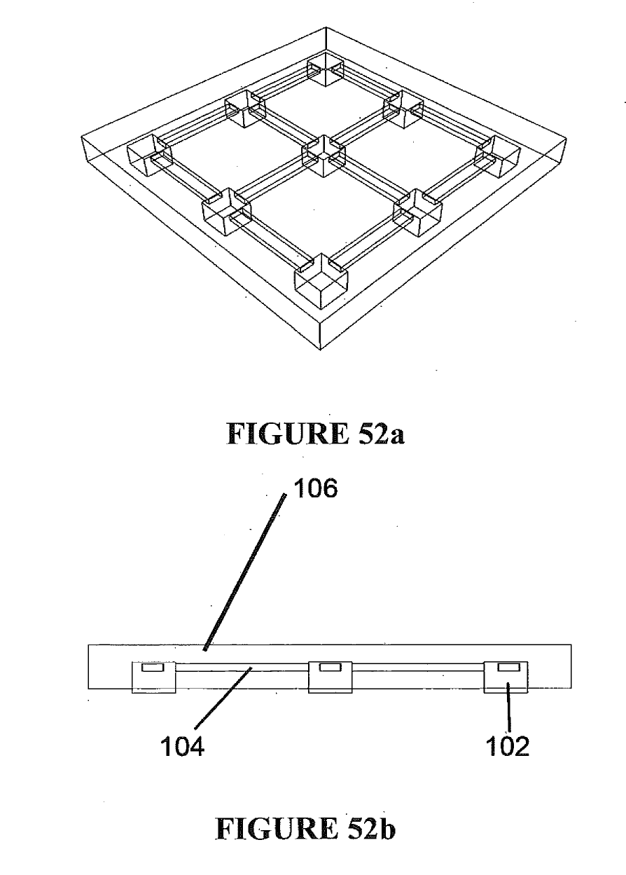

FIGS. 52a and 52b illustrates an alternative embodiment in which control points 102 and control point connectors 104 are embedded into a covering 106. Alternatively, the control points 102 may be embedded into the additional layer 702 or exterior surface 704. In this alternative embodiment, the control points are substantially flush with a lower surface of the covering.

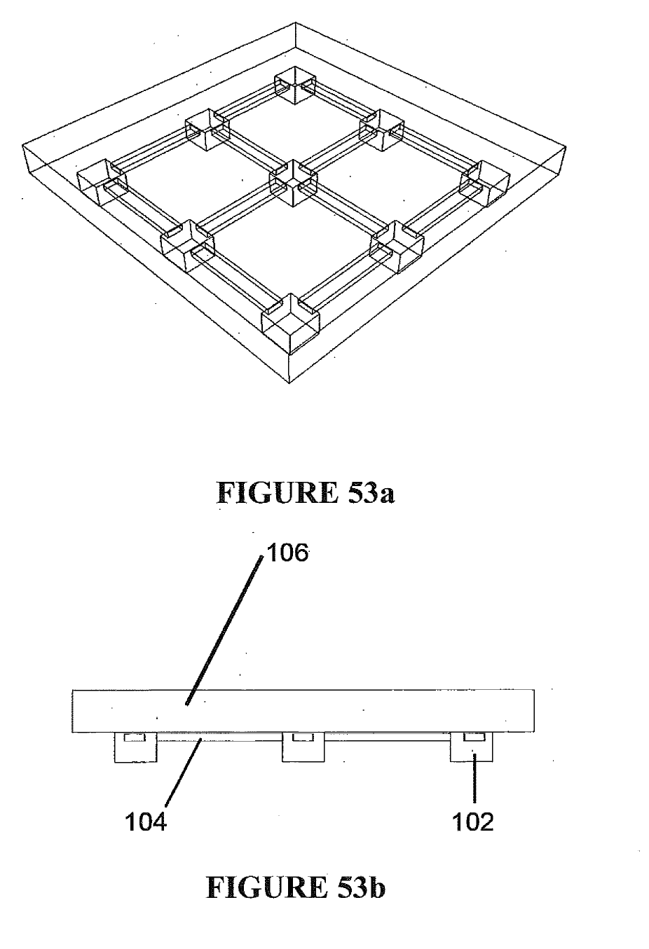

FIGS. 53a and 53b illustrates an alternative embodiment in which control points 102 and control point connectors 104 are attached to a covering 106. Alternatively, the control points 102 may be attached to the, additional layer 702 or exterior surface 704. In this alternative embodiment, the control points and control point connectors are attached to a lower surface of the covering and extend away from the covering.

FIGS. 54a and 54b illustrates an alternative embodiment in which an expanding and contracting web 7602 is embedded into a covering 106. Alternatively, the expanding and contracting web 7602 may be embedded into the additional layer 702 or exterior surface 704. In this alternative embodiment, the expanding and contracting web 7602 is substantially flush with a lower surface of the covering.

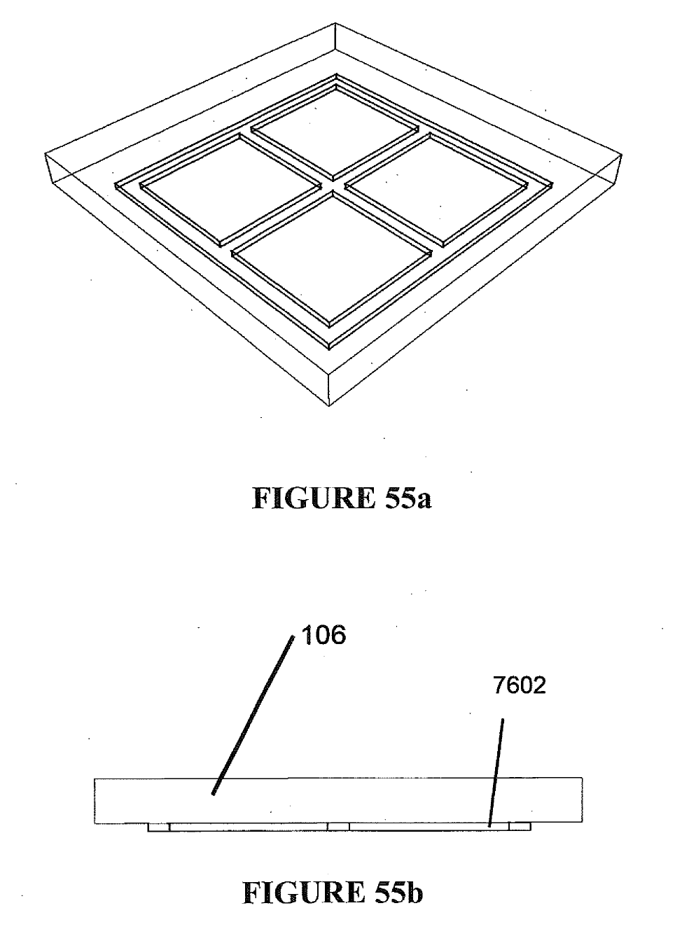

FIGS. 55a and 55b illustrates that an expanding and contracting web 7602 is attached to a covering 106. Alternatively, the expanding and contracting web 7602 may be attached to the additional layer 702 or exterior surface 704. In this alternative embodiment, the expanding and contracting web 7602 is attached to a lower surface of the covering and extends away from the covering.

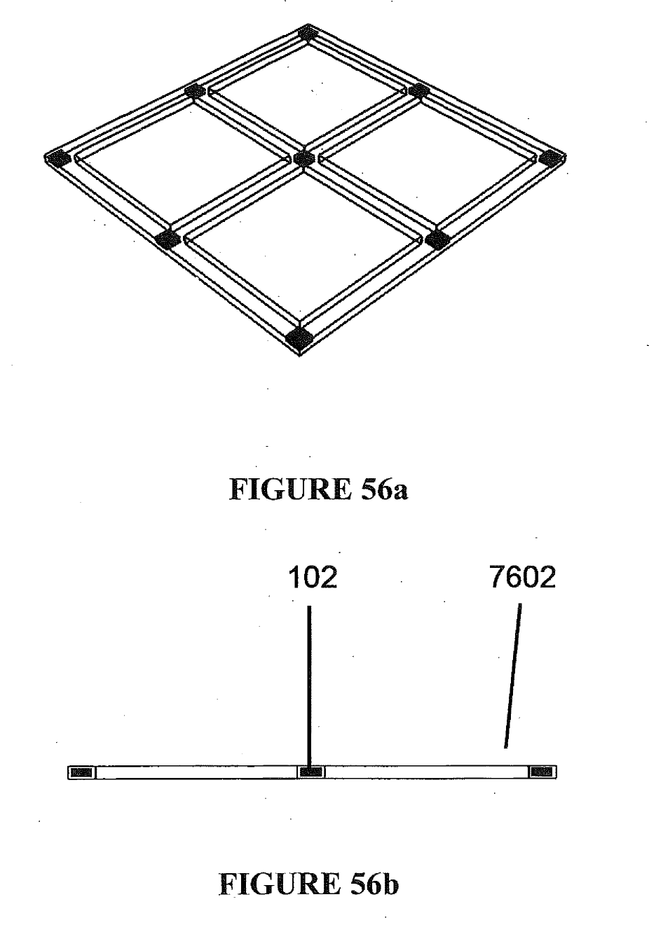

FIGS. 56a and 56b illustrates an alternative embodiment in which control points 102 are embedded into an expanding and contracting web 7602. In this alternative embodiment, the control points are substantially flush with the expanding and contracting web 7602.

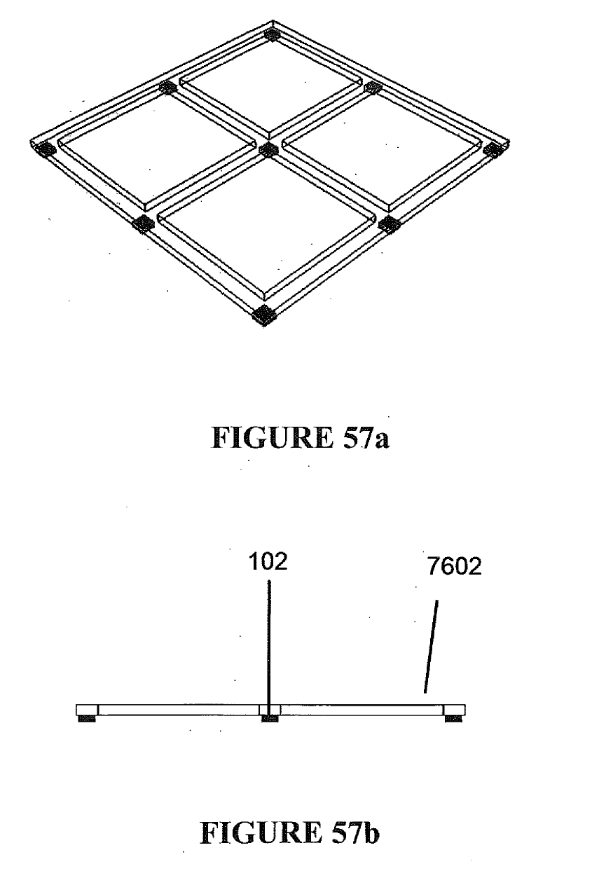

FIGS. 57a and 57b illustrates an alternative embodiment in which the control points 102 are attached to an expanding and contracting web 7602. In this alternative embodiment, the control points are attached to a lower surface of the expanding and contracting web and extend away from the expanding and contracting web.

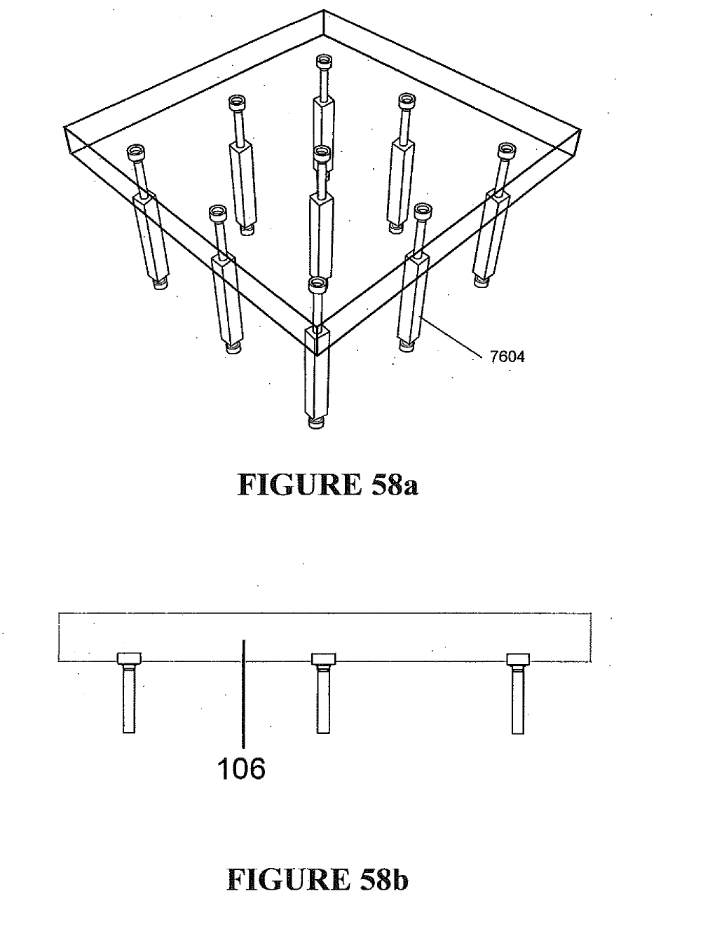

FIGS. 58a and 58b illustrates an alternative embodiment in which an actuation system 7604 is embedded into the covering 106. Alternatively, an actuation system 7604 may be embedded into the additional layer 702 or exterior surface 704. In this alternative embodiment, the control points of the deformable robotic surface are effectively integrally formed with the covering, additional layer or exterior surface rather than being separately formed components as shown and described in relation to FIGS. 50A to 55A.

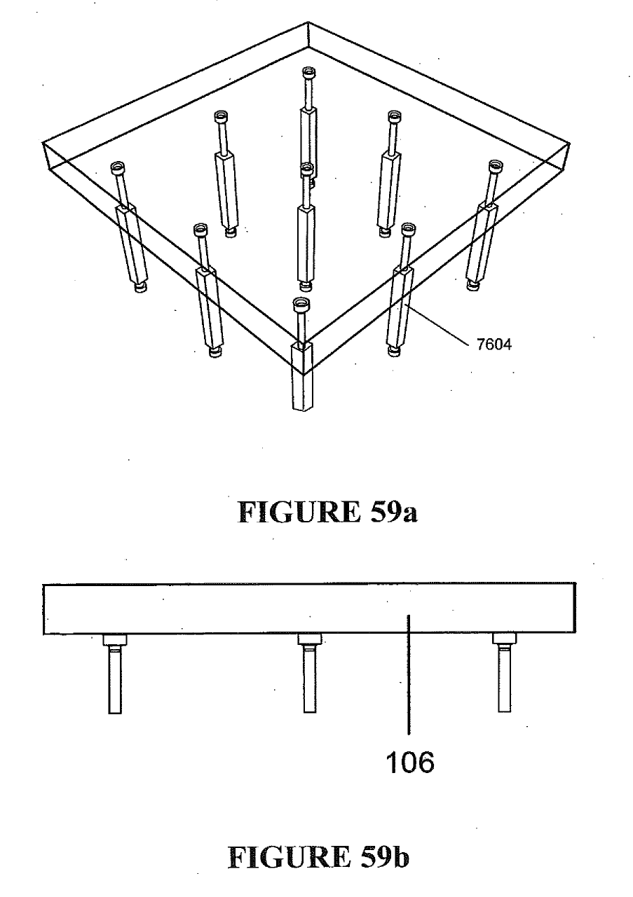

FIGS. 59a and 59b illustrates that an actuation system 7604 can be attached to the covering 106. Alternatively, an actuation system 7604 may be attached to the additional layer 702 or exterior surface 704. In this alternative embodiment, the control points of the deformable robotic surface are effectively integrally formed with the covering, additional layer or exterior surface rather than being separately formed components as shown and described in relation to FIGS. 50A to 55A.

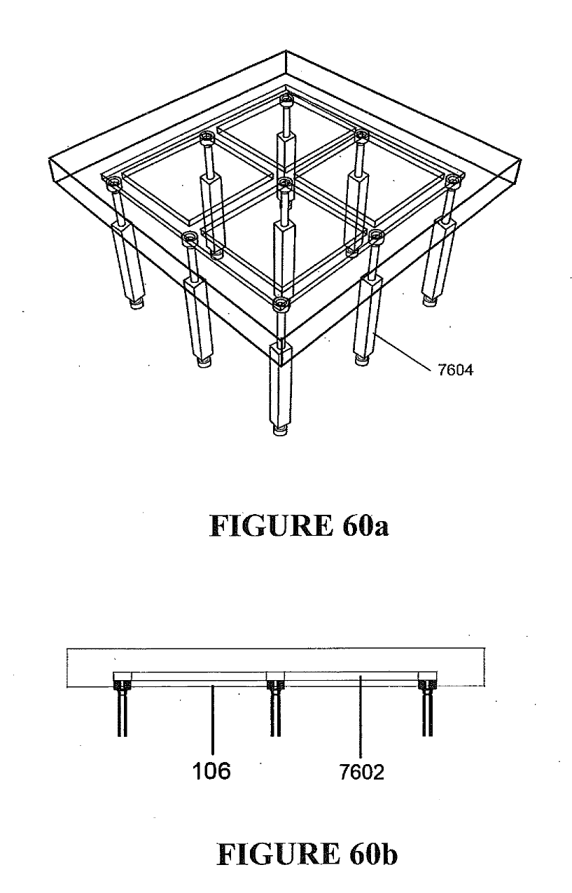

FIGS. 60a and 60b illustrates that an actuation system 7604 and an expanding and contracting web 7602 can be embedded into the covering 106. Alternatively, an actuation system 7604 may be embedded to the additional layer 702 or exterior surface 704. In this alternative embodiment, the control points of the deformable robotic surface are effectively integrally formed with either the covering, additional layer, exterior surface, or the expanding and contracting web rather than being separately formed components as shown and described in relation to FIGS. 50A to 55A.

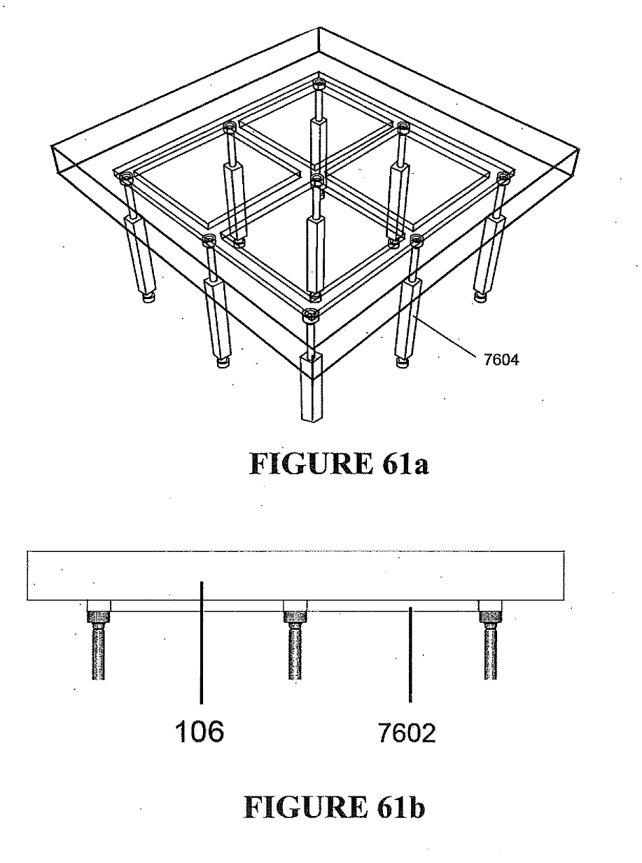

FIGS. 61a and 61b illustrates that an actuation system 7604 and an expanding and contracting web 7602 can be attached to the covering 106. Alternatively, an expanding and contracting web 7602 may be attached to the additional layer 702 or exterior surface 704. In this alternative embodiment, the control points of the deformable robotic surface are integrally formed with either the covering, additional layer, exterior surface, or the expanding and contracting web rather than being separately formed components as shown and described in relation to FIGS. 50a to 55a.

### Computer Simulations

Computer simulations are useful when designing and testing a robot or a deformable robotic surface. Simulations created in 3d software, can test the design of a robot or deformable robotic surface, in movement, to ensure that everything works within the 3d simulation first. Once a working simulation has been created, the parts can be built and assembled and then the animation can be exported to the assembled robot. Methods that may be used to aid the design process can be, but are not limited to: mapping motion, 3d animation, testing the artificial muscle system, designing the deformable robotic surface, for example.

Determining Actuator Movement from 3d Simulations

The movement of the physical actuation/muscle system can be created in 3d programs by using the animated vertex information to drive a computer generated actuation system that resembles the physical actuation system. This can be done by constraining the 3d actuation system to a vertex to one side of a 3d computer generated actuator and constraining a connection point to the opposite side of the 3d actuator. When the vertex moves, the 3d actuators are actuated in time and space to expand as necessary to match the vertex positions throughout time. Adjustments may need to be made to the 3d actuation system for this to work.

Once the 3d actuation system can match the vertex positions, the constrained motion can be baked onto the animated channels of the 3d actuators. Now that 3d actuators have animation curves applied to them, they can animate without the aid of the constraints. Once this has been achieved, the animation can be exported on to the physical actuation devices that are attached to the robot. Now, the corresponding points can be moved to the same space and time as the 3d actuation system, if the physical system matches the computer simulation.

The embodiments described in this specification illustrate ways in which the deformable robotic surface can be designed to create a deformable robotic surface for an artificial organism which is based on an actual organism. In the embodiments described, a well designed deformable robotic surface with a proper actuation/artificial muscle system can mimic an organism's superficial skin volume, throughout its range of motion, thus creating a deformable surface that mimics or the organisms' surface volume and deformations throughout its range of motion.

### Placement of Control Points

The placement of the control points 102 can be determined by the organisms' bone, muscle, fat and skin structure, which makes the ideal control point layout for each organism. The placement may be improved by taking into consideration which of the fore-mentioned factors is most dominant in the superficial skin deformations in a particular part of the body throughout its range of motion. In a human face; the skin, fat and bones are the primary considerations. In the hands and feet; the bones and folds of the skin are the primary considerations. The rest of the body is primarily determined by muscle, fat, and bone structure. These control point layouts are further explored in the following paragraphs.

### Artificial Thigh

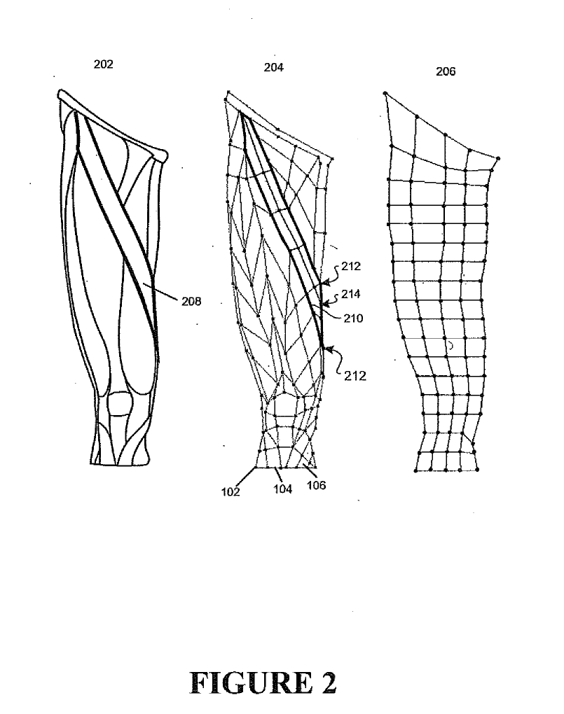

FIG. 2 illustrates detailed images of an organisms' thigh muscle 202 and a preferred control point 102 and control point connector 104 layout of a corresponding artificial thigh of a deformable robotic surface 204. Control points 102 provide key positions from which the artificial skin/exterior surface 704 can be manipulated. The control points 102 in the artificial thigh 204 are placed in such a way that they generally flow in the same direction as the underlying superficial muscle structure of the organisms' thigh 202. To further illustrate this, compare a Sartorius muscle of the organism 208, to the representation of the Sartorius muscle of the deformable robotic surface 210. The representation of the Sartorius muscle 210 on the deformable robotic surface is outlined by the two outer rows of control points 212.

A dark outer outline along the border of the control point connectors 104 helps to illustrate the similarities between the organism muscle and the deformable robotic surface design. Additionally, there is an inner row of control points 214. This deformable robotic surface is designed in such a way that to flex the artificial muscle, the inner set of control point 214 are raised in a direction towards the cover 106 and the outer set of control points 212 can be depressed or withdrawn in a direction away from the cover 106. The push and pull of these points by the actuators allows these deformations to express the similar kind of volume change that takes place on the organism's Sartorius muscle, throughout its range of motion.

There are many alternative control point 102 layouts that could be used create similar results. For example, an alternative layout 206 of the control points 102 and control point connectors is shown in FIG. 2. However, the results given by this alternative layout 206 may not give as much control on the deformations as the previously discussed preferred layout 204.

### Artificial Face

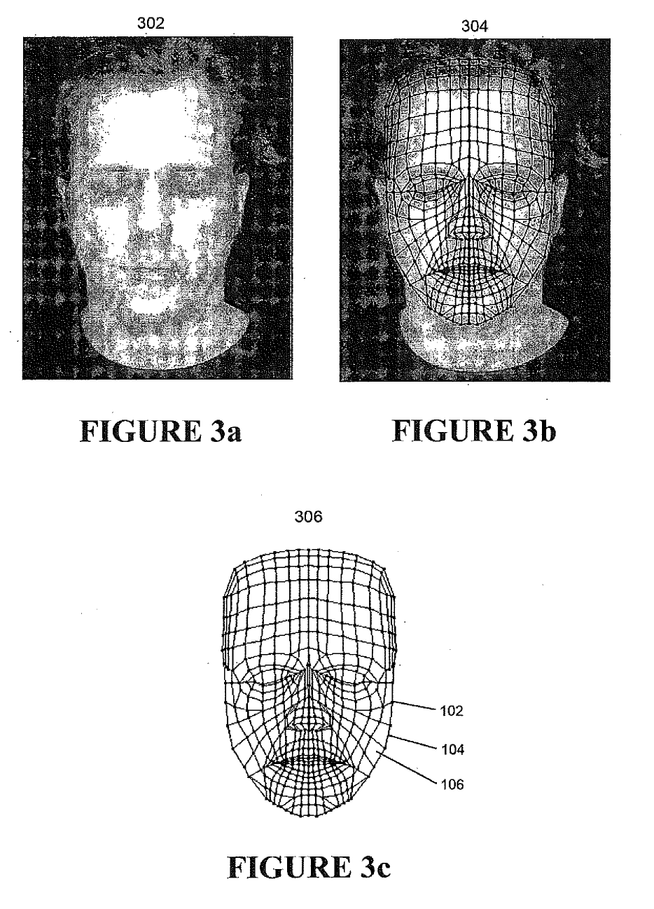

FIG. 3a is a front view of an organism's face 302 and FIG. 3b is a front view of the organism's face of FIG. 3b together with an overlying layout 304 of control points 102, control point connectors 104, and coverings 106 for a deformable robotic surface in the form of an artificial face. FIG. 3c is the layout 306 of control points, control point connectors, and coverings of FIG. 3b without the organism's face.

In a human's face, the muscles weave in and out so intricately that it is very difficult to mimic all of the superficial muscles of a human face. Therefore, the best way to determine the layout of the control points 102 is to determine the range of expressions the face makes and arrange the control points 102 in a manner that they can best describe all of these expressions. The Facial Action Coding System (FACS), designed by Paul Ekman, describes a fairly complete range of facial expression. When placing these control points 102, each FACS pose should be carefully considered so that most of the details in the face can be re-created with the control points 102 by repositioning the control points 102, to match the organism FACS range of expression with the deformable robotic surface. There are many other control point configurations that can be used, however 304 and 306, illustrate a preferred layout for this organism's face. Each organism has a unique range of facial expressions; therefore the placement of the control points is best determined from each organism's facial range of motion (expression).

If the actuated deformable robotic surface can repeat all of the FACS poses of the organism, then these poses can be combined/blended to create almost any facial expression that the organism can make. However, even though the FACS poses give a fairly wide range of expression, at times, it may be necessary to add more poses to encompass a wider range of expression. This is because there are many subtleties of facial expression that are difficult to capture in static poses with isolated muscle movements.

There are multiple methods commonly used in 3D computer graphics to solve data captured from an organism, into these FACS expressions. This solved data or animation can be applied to the actuators to move the control points 102 to the desired locations in space and time, to match an organism facial expressions.

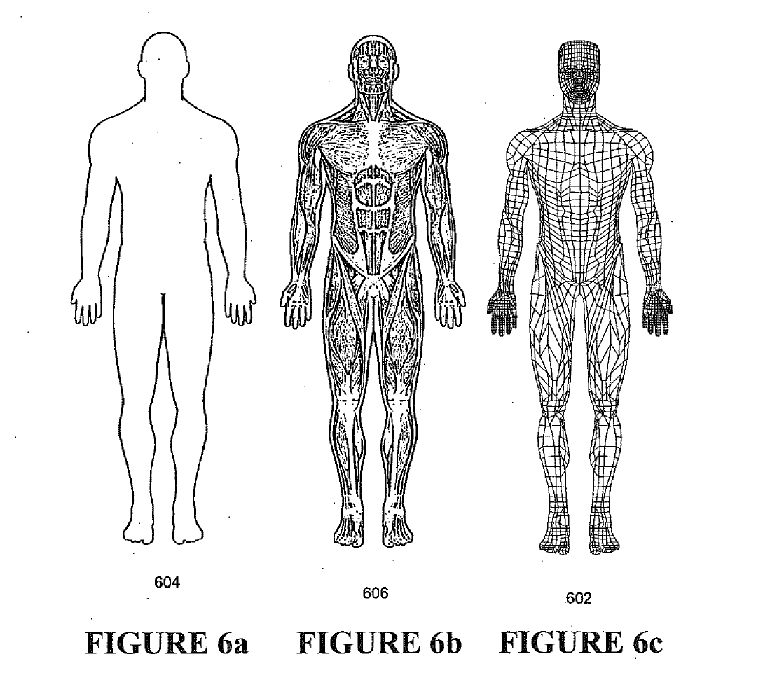

FIGS. 6a, 6b, and 6c illustrate the relationship between an organism 604, an organism's musculoskeletal system 606 and a deformable robotic surface 602. FIG. 6a is a schematic of a human being and FIG. 6b shows the layout of a human being's muscular system. FIG. 6c is the layout of control points, control point connectors, and coverings corresponding to the muscular system shown in FIG. 6b.

FIG. 6 also illustrates how an organism's muscle system correspond to the layout of the control points 102 and the control point connectors 104 of the deformable robotic surface. FIG. 6 shows that the layout of the control points and control point connectors are generally aligned in rows and columns. However, the control points and control point connectors may deviate from the rows and columns to form non-square areas between the control points and control point connectors. For example, FIG. 6 shows the areas between the control points 102 and control point connectors 104 may be generally triangular, have a generally parallelogram-type shape, or have a generally hexagonal-type shape. Additionally, the areas between the control points and control point connectors may be wider or taller on one side than the other side and/or wider or taller towards the top compared to the bottom.

### Internal Deformable Robotic Surfaces

In the embodiments described above, the deformable robotic surface has been presented primarily as a method to deform an exterior surface 704. However, the deformable robotic surface can also be used to create internal muscles. Therefore, an artificial organism's robotic surface can be classified into two primary types: external deformable robotic surfaces 508 and an internal deformable robotic surface 504. External deformable robotic surfaces 508 are deformable robotic surfaces that directly affect the exterior surfaces 704 deformations. Internal deformable robotic surfaces 504 are deformable robotic surfaces which can be used to create internal surfaces, which may resemble the organism's internal structure.

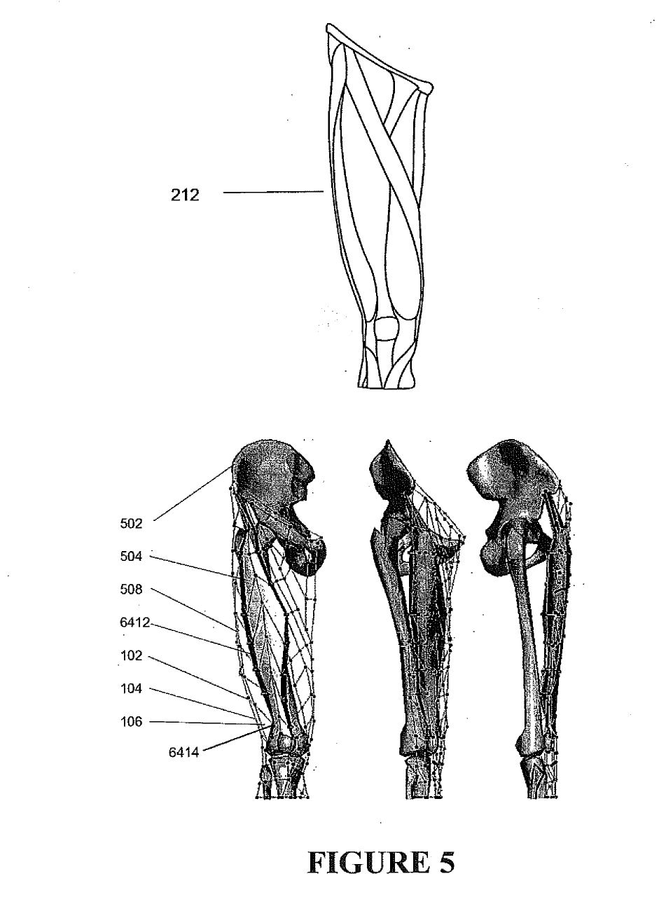

FIG. 5 illustrates the difference between internal deformable robotic surfaces 504 and external deformable robotic surfaces 508. FIG. 5 also illustrates how the control points 6414 and control point connectors 6412 can be blended together and attached to artificial bones 502.

Internal deformable robotic surfaces 504 may be similar in shape and size to the organism's muscles. It is not necessary that every corresponding muscle of the organism's muscle system is re-created in the internal deformable robotic surfaces. A grouping or simplification can be done; as long as the external deformable robotic surface 508 can mimic the organisms' superficial volume, throughout its desired range of motion.

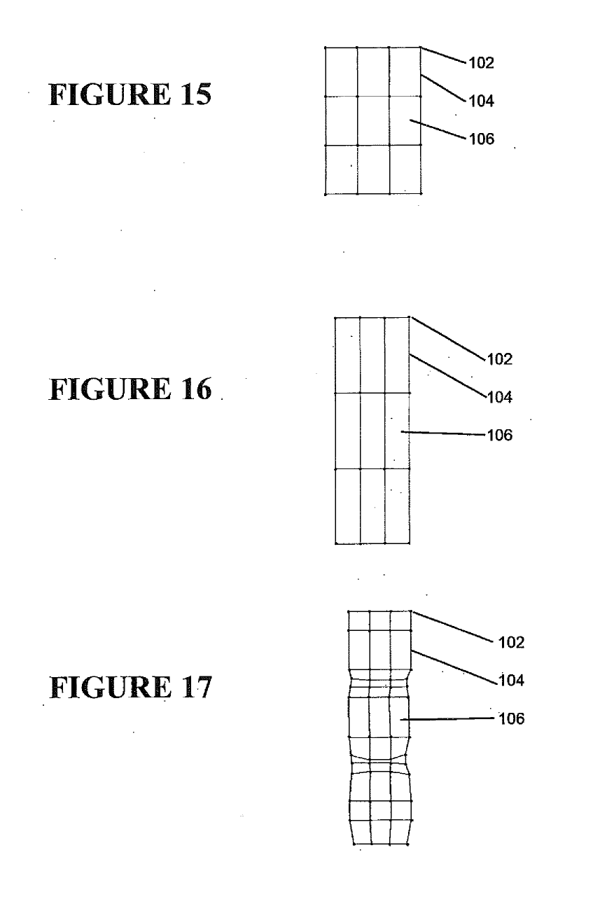

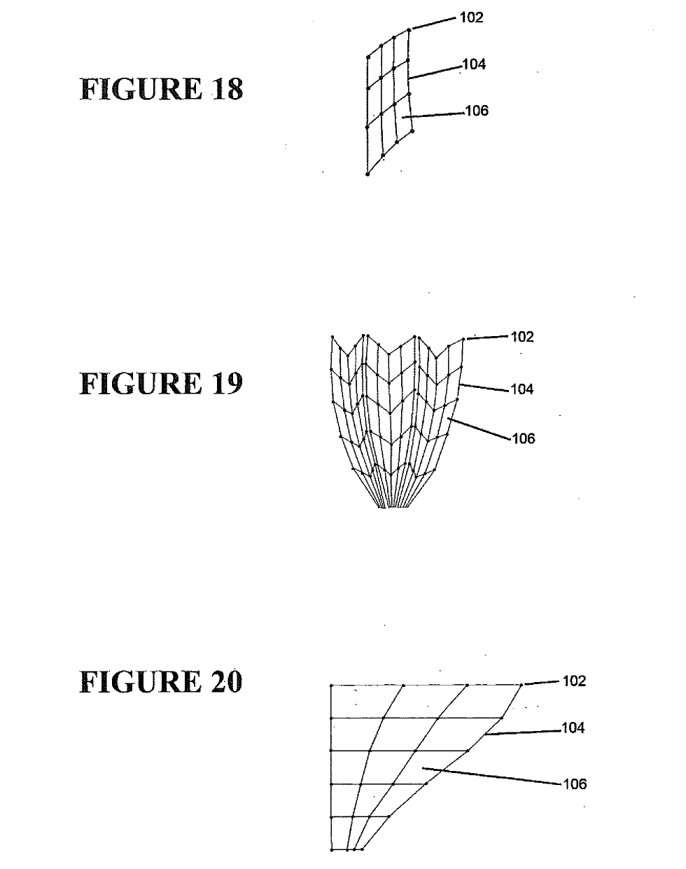

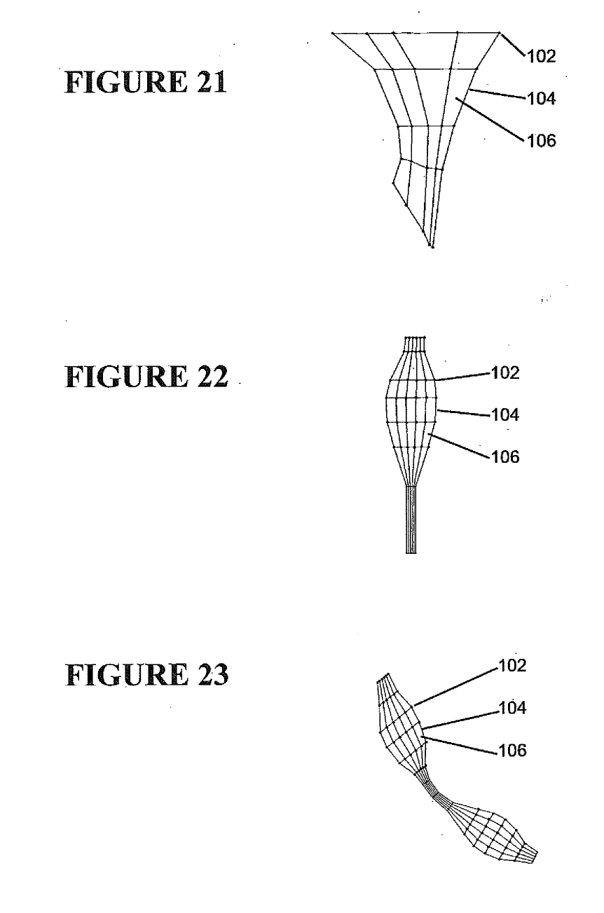

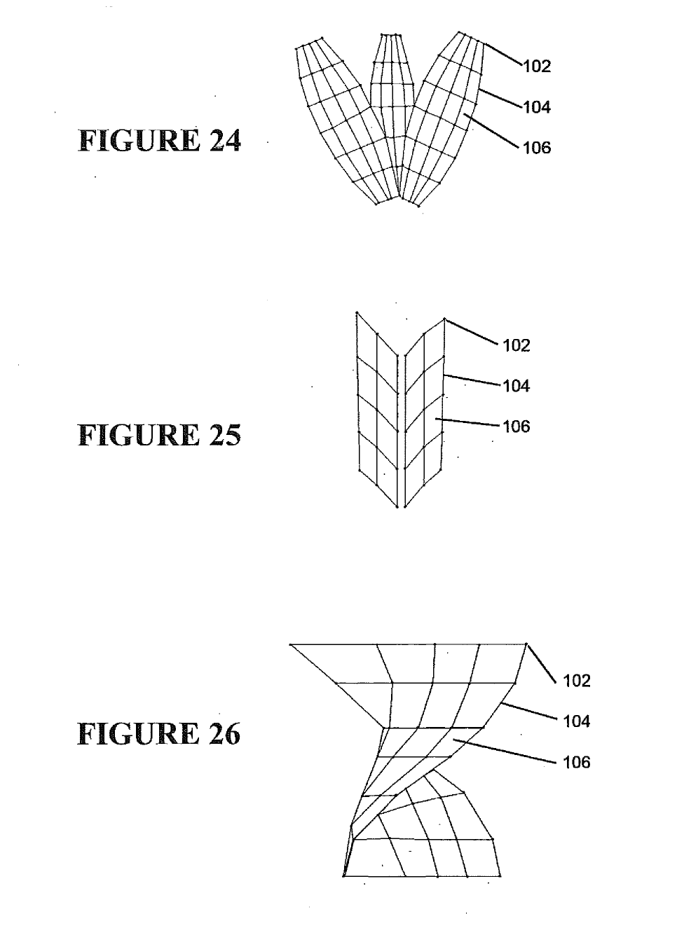

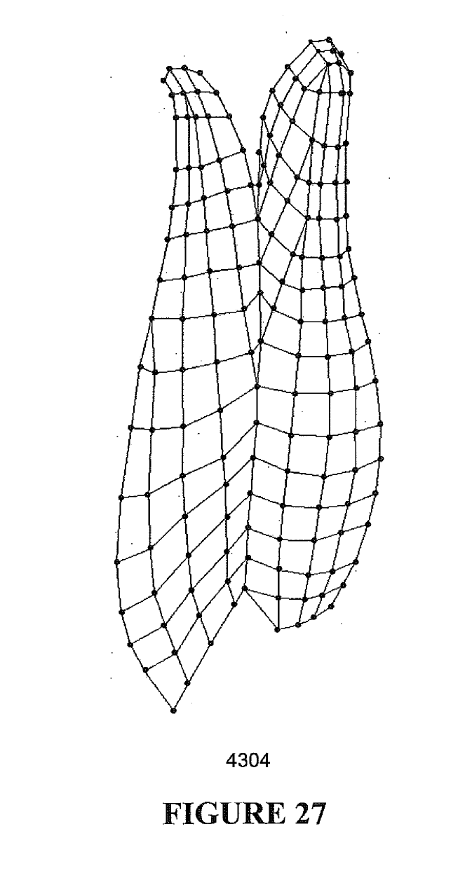

FIG. 15-FIG. 27 illustrate several different deformable robotic surface 504 equivalents of various types of muscles in a human body. These designs can be useful when designing internal deformable robotic surfaces 504. However, there can be many variations and combination created for desired effects. For example, one variation is illustrated in FIG. 27. It shows that two different muscles of an organism can be combined to form as single internal deformable robotic surface 4304.

FIG. 15-FIG. 27 show that the control points and control point connectors may deviate from the rows and columns to form non-square areas between the control points and control point connectors. For example, FIG. 6 shows the areas between the control points 102 and control point connectors 104 may be generally triangular, have a generally parallelogram-type shape, or have a generally hexagonal-type shape. Additionally, the areas between the control points and control point connectors may be wider or taller on one side than the other side and/or wider or taller towards the top compared to the bottom.

Additionally, FIG. 15-FIG. 27 show that the deformable robotic surface may have a three-dimensional layout when in a neutral position. Specific examples are shown in FIG. 23, FIG. 26, and FIG. 27, for example.

Control points 102 attached to the internal deformable robotic surfaces 504 can be connected to the control points 102 of the external deformable robotic surface 508, therefore transferring the actuation from the actuation system, to the internal deformable robotic surface 504, to the external deformable robotic surface 508. If desired, the internal deformable robotic surfaces 504 and the external deformable robotic surfaces 508 may be connected to one another. These shared or connected control points 102 can be useful in reducing the number of control points 102 needed to create the actuation.

The covering 106 may be attached to the interior or exterior of the control points 102 and the control point connectors 104. For the external surfaces, like the skin, the covering 106 can be applied on the side closest to the skin. When creating some internal deformable robotic surfaces, it may be more desirable to place the covering internally.

In addition, the deformable robotic surfaces may be filled with fluids and/or other materials 512 that mimic the weight and flexibly of the organic muscles and fat, thus creating an artificial muscle and fat volume that more closely resembles organism. These materials may be, but are not limited to, water, hydraulic fluid, silicon, or air, for example.

### Alterations

The design of the deformable robotic surface may be altered to be different to the organism to create many different effects. However, when creating an altered artificial organism, the organism can still be referenced during the design process. Alterations can include, but are not limited to: characterizations, morphing, different organisms combined together to make a single deformable robotic surface, for example.

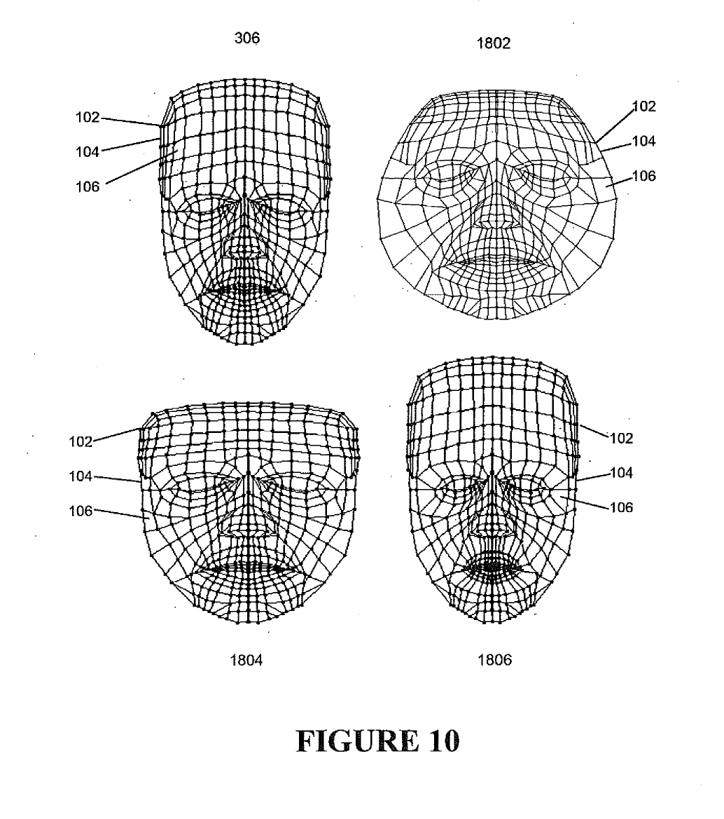

FIG. 10 illustrates some characterized deformable robotic surfaces. Characterizations can be classified as a difference in the visual appearance between the organism and the deformable robotic surface. Characterizations can include, but are not limited to:

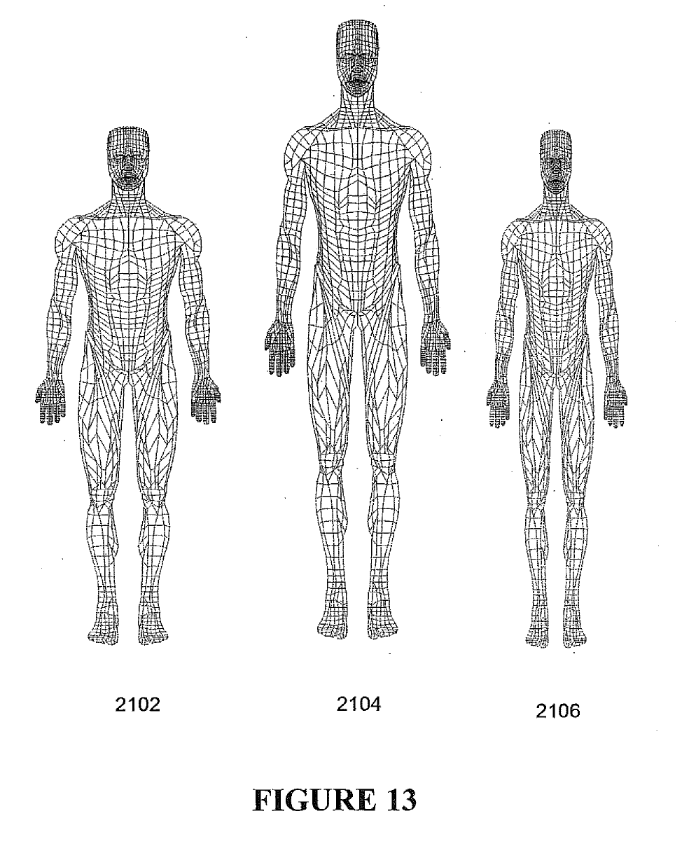

FIG. 13 shows proportional and non-proportional scale changes applied to the deformable robotic surface.

(B) Non-proportional scales applied to exaggerate the organism's features 1804 and 1806

(C) Changes in the physical structure of the artificial organism that differs from that of the organism 1802.

FIG. 13 illustrates views of a deformable robotic surface with a proportional scale applied on different axis. One view shows a deformable robotic surface normal scale 2102. Another view shows a deformable robotic surface with scale applied on its y axis 2104. Another view shows a deformable robotic surface with scale applied on its x axis 2106.

### Morphing

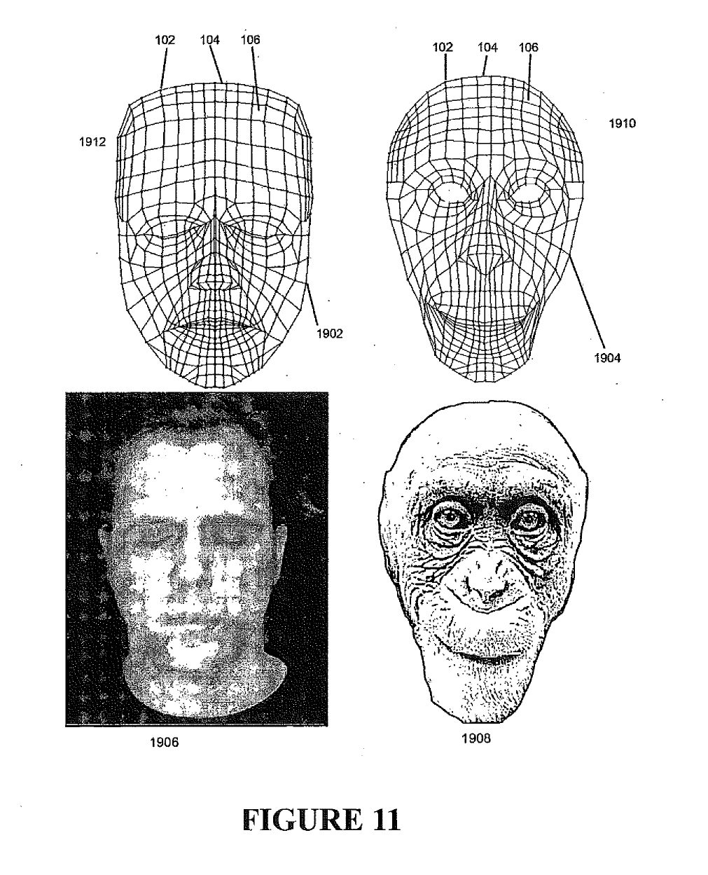

FIG. 11 shows an organism's face 1906 and corresponding deformable robotic surface 1902 together with the face 1908 of a different organism and corresponding deformable robotic surface 1904. FIG. 11 illustrates that a deformable robotic surface can morph from one artificial organism to another. In a preferred embodiment of the s method works, the artificial organism or characterized organism have the same number of control points 102 that relate to similar parts of the body. Also, the actuation system is preferably capable of actuating the control point 102 through the range of motion of the target and destination character. This allows the control points 102 to be moved to the preferred space of each organism's range of motion. The example shown in FIG. 11 illustrates that the control point 1902 is the same control point as 1904 however; it has be actuated to a new location so that a different artificial organisms can be represented. Examples can include, but are not limited to a face morphed into different face, a realistic face morphed into a characterized one, a human face morphed into a monkey's face, for example.

### Mixing Body Parts

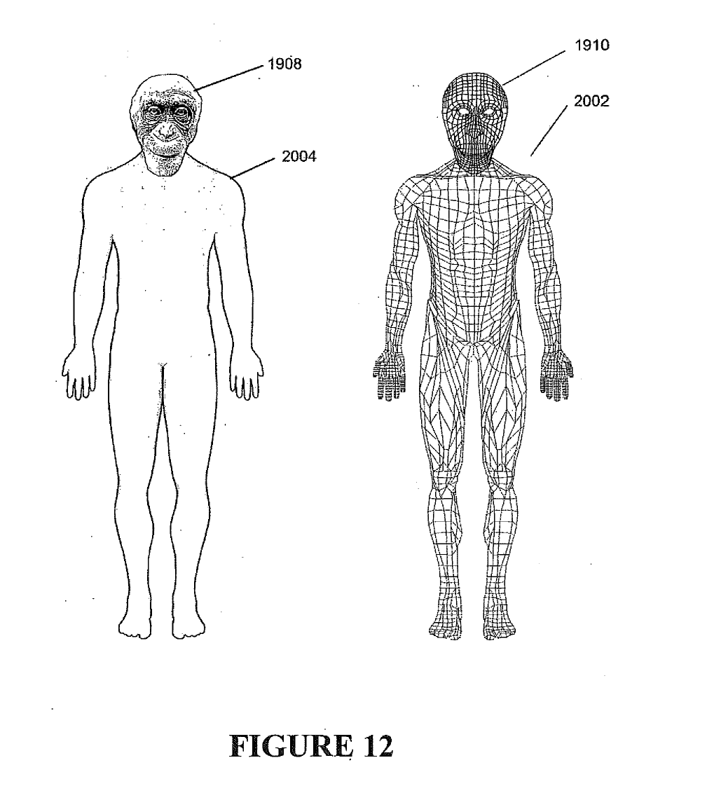

Mixing body parts of different organisms together can create many unique deformable robotic surfaces. FIG. 12 illustrates a method to mix different organisms together to create a deformable robotic surface. In this drawing, the two organisms that have been chosen are a human's body 2002 and a monkey's head 1910. There is an endless combination of organisms or organism and objects can be created. Combinations could include, but are not limited to, a rabbit body with a squirrel head, a crocodile legs attached to dog's body with a rabbit head, for example.

### Details

Once the artificial skin/exterior surface 704 has been added, attaching additional levels of detail can aid in making the artificial organism more believable. Some example detailing can include, but is not limited to, cloned hair, transplanted hair, wigs—artificial hair, other synthetic hair, fake nails, special effects makeup, and cosmetics, for example.

### Creating an Artificial Organism

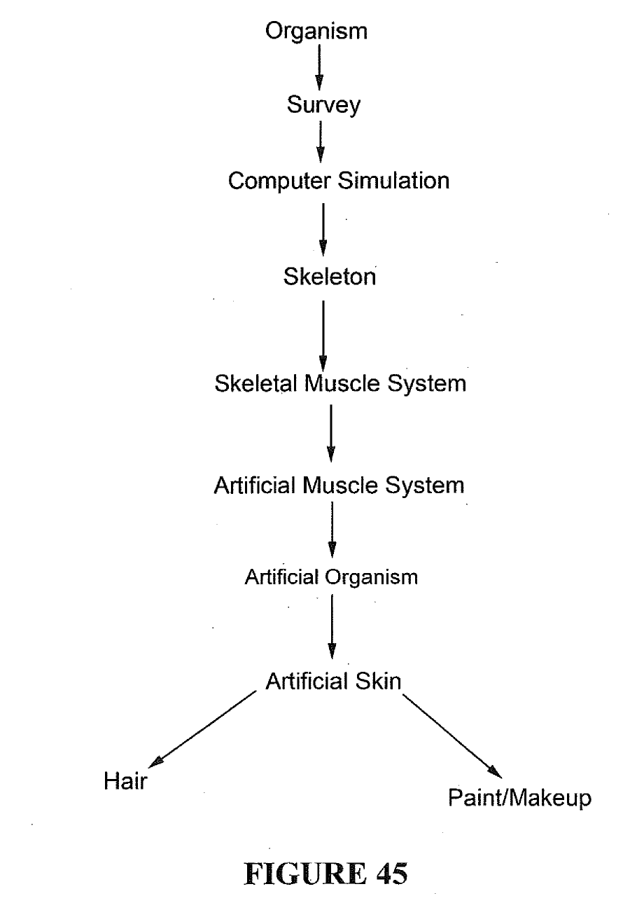

FIG. 45 illustrates a general flowchart of a method to create an artificial organism. The organism is surveyed and a computer simulation is created. An artificial skeleton is created, followed by a skeletal muscle system, and then an artificial muscle system. An exterior deformable robotic surface is created and the artificial skeleton, skeletal muscle system, artificial muscle system, and exterior deformable robotic surface are assembled to form an artificial organism. Artificial skin may be applied together with hair and paint or makeup.

### Surveying the Organism

By surveying an organism with various methods, information can be gathered and calculated in ways to aid in design of an artificial organism. This data can be used to calibrate the artificial muscle/actuation system, to improve the deformable robotic surface design and in general improve the accuracy and overall design of the robot by matching the surface of the robot to the captured data. In the following paragraphs, there will be several methods listed to do this; however there are other methods that could be applied to further improve results.

### Range of Motion

When surveying an organism, it is generally a good idea to survey as broad of a range of motion as the surveying devices allows. A broad range of motion can include; but is not limited to:

(A) each of the organisms muscles contracted individually, when possible

(B) each of the muscles relaxed

(C) groups of muscles flexed together

(D) the organisms muscles in motion

(E) the organisms muscles in motion with forces acting upon them

(F) dynamics of the skin and muscle in motion

When surveying the organism, it is a good idea to capture a neutral pose. The neutral pose can be defined as the rest pose from which all other deformations are base off of. The neutral pose for a human subject could be a standing position with an upright posture, feet directly underneath the shoulders, the head facing forward and the arms perpendicular to the body with the hands facing down. There are different variations to the neutral pose that can be used to.

### Fitting Technique

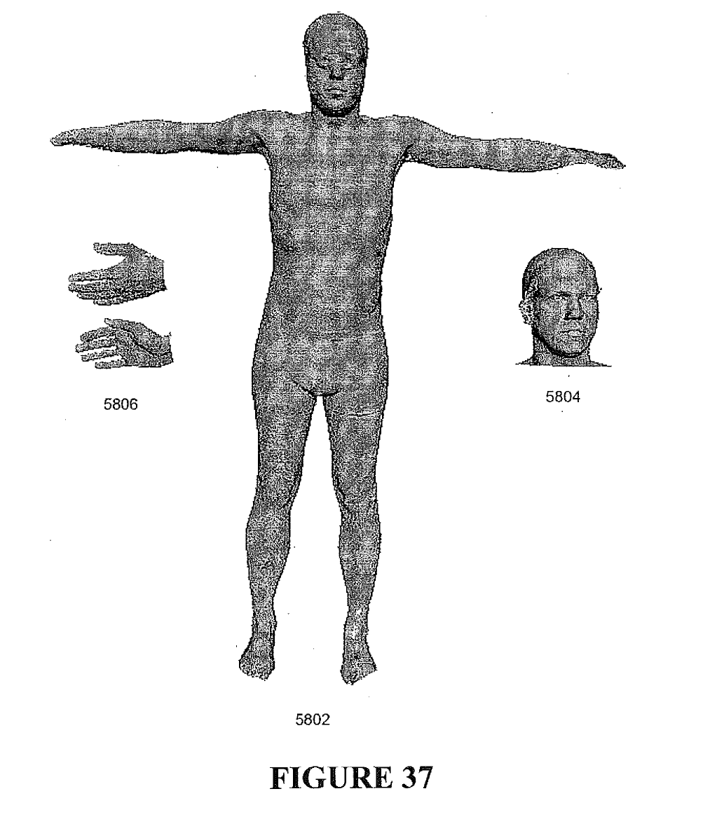

The accuracy of the mapping from the organism, to the 3d generated character, to the deformable robotic surface, can be improved when the organism skin and musculoskeletal system are surveyed. Each technology used to survey the organism can provide different information. The data collected from each device can be combined to create a fairly accurate picture of the internal and external workings of the organism. When possible, devices can be used to scan the entire body, throughout the entire range of motion, to collect as much information about the internal and external structure of the organism as possible. FIG. 37 shows 3d scans of a body 5802, a head 5804, and a hand 5806. Once the data is collected, the surveyed data can be processed mathematically using algorithms to best fit the data together and create the most detailed view of the organism as possible. By evaluating the quality of data each surveying device provides, certain levels of accuracy can be used to define different parts of the robot. For example, an x-ray might describe the bones joint placement more effectively than a 3d scan would. In this situation, the 3d scans would be better for calculating the deformations of the skin and the x-rays would be more effective in determining the placement of the bones. Some technologies that could be used to survey the organism with can include, but are not limited to X-Ray, MRI, Cameras, 3d computer scans, and video, for example.

Once all the data has been collected from all of the multiple methods listed above, the data can be mathematically solved to a 3d character that mimics the physical artificial organism that is being created. Once a good simulation is created in the computer, this design can be used for a deformable robotic surface.

### Motion Capture

Motion capture technologies can be used to collect data from an organism throughout space and time. The captured data can be used to determine how the control points 102 of the deformable robotic surface should move in order to match that of the organism. Motion capturing devices could include, but are not limited too are Optical, Magnetic, GPS, and 3D scanning.

Once the data has been collected, mathematical predictions can be made to determine where the deformable robotic surface's control points 102 should be in space and time to match that of the organism. For best results, the placement of these motion capture markers should be located on the organism in the same relative location that the corresponding control points are located on the deformable robotic surface. This direct mapping will provide a relatively precise location throughout time, that each of the deformable robotic surface's control points need to be at, in order to match the movement of the organism. If there is not an exact mapping between the motion capture markers and the deformable robotic surface, retargeting methods can be used.

### Retargeting

There are various kinds of motion capture devices and software that can be used to capture the organism's movement and retarget it to the deformable robotic surface. When retargeting the movement of an organism's performance to an artificial organism, there can be a one to one mapping, if there is a corresponding motion capture marker, for each of the control points 102. When retargeting an organism motion to a characterized deformable robotic surface several retargeting methods can be used. These retargeting methods can include, but are not limited to: GLOBAL Optimization, Least Square Optimization, AutoDesk Motionbuilder's actor solving method, various other optimization techniques, EVA Real-time solver.

FIG. 37 illustrates some 3d scans of an organism. As stated, 3d scans can be used as a reference to design the deformable robotic surface and the rest of the robot as well. These 3D scans can be used to match the deformable robotic surface to the organism's superficial volume. Ideally, it is a good idea to create as many scans as possible, in various positions throughout the organism's range of motion. In turn, this will give a much denser data set, which provides more information about how that organism moves.

The control point's 102 range of motion can also be determined by the range of motion captured in the survey. For example, to determine the range of motion of the organism's bicep, three 3D scans can be used. The neutral scan, a scan with the tricep fully contracted and a scan with the bicep fully contracted. These scans provide a simplified version of the superficial volume of the organism's bicep in motion. Therefore the deformable robotic surface and actuation system can be adjusted to match this superficial volume in motion. If more scans are used to define the organism's bicep range of motion the more accurate the surface volume can be defined.

Surveyed data can be fitted to the neutral pose. This can be more precisely accomplished by using mathematical optimization algorithms, such as, but not limited to, least squares and global optimization, and iterative closest point, for example. The goal is to minimize the difference in the data between the neutral pose and the range of motion data. However, before the sets of data are fitted together, it is important to define the surface area that you would like to fit to. It is best to use relaxed regions of each of the range of motion data sets and fit that area to a corresponding surface area of the neutral data set. Areas of the data that have flexed muscles can be filtered out. The surfaces can be matched by comparing the difference of between the two relaxed surfaces and aligning them, by translating, rotating and scaling the range of motion data until the best fit is found that corresponds to the regions of the neutral data set.

Once the data is fitted to the neutral pose, a computer representation of the deformable robotic surface is created manually or procedurally from the neutral and the surveyed data. This computerized representation of the deformable robotic surface should be able to match the surfaces of each of the fitted pieces of data, throughout the range of motion by moving the vertices or control points of the computerized deformable robotic surface to the corresponding surface of the fitted data. If this is not possible, the deformable robotic surface can be redesigned until this is possible.

Mathematical optimization techniques, which can include, but are not limited to, least squares and global optimization, can aid in determining the range of motion needed by the actuation system to reach the range of motion in the surveyed data. In the 3d simulation, the 3d muscle actuation system, that mimics the robotic actuation system, can be automatically adjusted (solved) to reach the full range of the organisms muscle contractions by comparing the surrounding muscle deformations and solving the 3D muscles to best fit the surface of the surveyed data. If the 3D computer generated muscle system does not match that of the scans, an amount of error is returned that can inform the designer that more adjustments need to be made to the computer muscle system, in order that the muscle system reaches the desired location. This should be done until an acceptable amount of error has been created. Once an acceptable 3d muscle system is created, then the artificial muscles can be placed from this information and applied to the robot.

Optimization techniques can also be used to adjust attributes that modify the 3d characters skeletal system. This solved skeleton can be used as a design guide to build the robotic equivalents.

Thus the reader will see that the invention provides an integral or modular suit which can be deformed by an actuation/artificial muscle system, to create deformations that can be used to create physical deformable surfaces. This invention can create a surface which has been originally designed in the computer. In addition, this invention can form a network that can contain sensors and transfer and transmit energy, information, and actuation throughout the deformable robotic surface and to other parts of the robot or external devices.

While the above description contains many specificities, these should not be construed as limitations on the scope of the invention, but as exemplifications of the presently preferred embodiments thereof. Many other ramifications and variations are possible within the teachings of the invention. For example, DNA, from an organism, can be used to create computer simulations of the organism that show what an organism would look and behave like under different circumstance of their life. These circumstances could be but are not limited to: Age, lifestyle, weight, physical issues, and personality.

Once these predictions were made, the result could be calculated to make an estimated visual look of what the organism would have looked and behaved like. Then the deformable robotic surface can be designed based off of this information. In addition, the DNA of the organism could be altered for a different effect.

Preferred embodiments of the invention have been described by way of example only and modifications may be made thereto without departing from the scope of the invention.

For example, the cross section of the control point connectors are shown and described as being generally rectangular. The cross section of the control point connectors may be any other suitable shape, such as circular, square, or oval for example. Additionally or alternatively, the cross section of the control point connectors may vary along the length of the control point connector.

1. A deformable robotic surface comprising:
a plurality of control points, the control points being moveable relative to each other; and
a covering extending between the plurality of control points;
wherein movement of the control points relative to each other causes a corresponding movement of the covering.

2.-51. (canceled)

52. A physically deformable robotic surface as claimed in claim 1 further comprising a plurality of control point connectors, each control point connector connecting two control points of the plurality of control points.

53. A physically deformable robotic surface as claimed in claim 52, wherein at least a portion of the plurality of control point connectors comprise flexible connectors.

54. A physically deformable robotic surface as claimed in claim 53, wherein at least a portion of the plurality of control point connectors comprise resilient connectors.

55. A physically deformable robotic surface as claimed in claim 52, wherein at least a portion of the plurality of control point connectors comprise rigid control point connectors.

56. A physically deformable robotic surface as claimed in claim 52 wherein the rigid control point connectors comprise telescopic connectors.

57. A physically deformable robotic surface as claimed in claim 52 wherein at least a portion of the control point connectors are generally straight components.

58. A physically deformable robotic surface as claimed in claim 52 wherein at least a portion of the control point connectors are generally curved components.

59. A physically deformable robotic surface as claimed in claim 52 wherein at least a portion of the control point connectors have at least one control point connection point to attach the covering to the control point connector.

60. A physically deformable robotic surface as claimed in claim 52, wherein the covering extends over the plurality of control point connectors.

61. A physically deformable robotic surface as claimed in claim 52 wherein at least a portion of the control point connectors are embedded in the covering.

62. A physically deformable robotic surface as claimed in claim 52, wherein the control point connectors are integrally formed with the covering.

63. A physically deformable robotic surface as claimed in claim 52, wherein the location of at least a portion of the control points and at least a portion of the control point connectors is printed on the covering.

64. A physically deformable robotic surface as claimed in claim 52, wherein the control points are integrally formed with the control point connectors as an expandable and contractible web.

65. An expandable and contractible web as claimed in claim 64 wherein at least a portion of the expandable and contractible web is an elastic net.

66. A physically deformable robotic surface as claimed in claim 64 wherein the expandable and contractible web correspond to edges of the computer representation.

67. A physically deformable robotic surface as claimed in claim 64 wherein the movement of the control points connectors or expandable and contractible web through time generally correspond to a computer represented movement of the edges of the computer representation through time.

68. A physically deformable robotic surface as claimed in claim 1, wherein the covering comprises a flexible covering.

69. A physically deformable robotic surface as claimed in claim 1, wherein the covering comprises a resilient covering.

70. A physically deformable robotic surface as claimed in claim 1, wherein the covering extends over the control points.

71. A physically deformable robotic surface as claimed in claim 1, wherein the control points are generally arranged in rows and columns to form a grid of control points.

72. A physically deformable robotic surface as claimed in claim 1, wherein the control points are generally arranged in triangular, rectangular, parallelogram-type and/or hexagonal-type shapes.

73. A physically deformable robotic surface as claimed in claim 1, further comprising at least one actuator for moving at least one of the control points relative to the other control points.

74. A physically deformable robotic surface as claimed in claim 73 wherein the at least one actuators comprises biasing means, electroactive polymers, mechanical and/or pneumatic actuators.

75. A physically deformable robotic surface as claimed in claim 74 wherein the biasing means comprises a spring.

76. A physically deformable robotic surface as claimed in claim 73 wherein the actuators are attached to the physically deformable robotic surface at attachment points.

77. A physically deformable robotic surface as claimed in claim 76 wherein the attachment points of the actuators correspond to vertices of a computer representation.

78. A physically deformable robotic surface as claimed in claim 76 wherein the movement of the control points or attachment points through time generally correspond to a computer represented movement of the vertices of the computer representation through time.

79. A physically deformable robotic surface as claimed in claim 1 wherein at least a portion of the control points comprise control point actuators that are adapted to move the control points relative to each other.

80. A physically deformable robotic surface as claimed in claim 79 wherein the control point actuators comprise biasing means, electroactive polymers, and/or pneumatic actuators.

81. A physically deformable robotic surface as claimed in claim 80 wherein the biasing means comprises a spring.

82. A physically deformable robotic surface as claimed in claim 1, further comprising at least one flexible support extending from a control point towards the covering to form a relatively smooth surface in the covering.

83. A physically deformable robotic surface as claimed in claim 1, wherein at least a portion of the control points are embedded in the covering.

84. A physically deformable robotic surface as claimed in claim 1, wherein the deformable robotic surface has a neutral configuration in which at least a majority of the covering is generally non-planar.

85. A physically deformable robotic surface as claimed in claim 1, wherein the physically deformable robotic surface has a neutral configuration in which at least a portion of the covering is generally curved.

86. A physically deformable robotic surface as claimed in claim 1 wherein the physically deformable robotic surface has a neutral configuration in which at least a majority of the covering is generally planar.

87. A physically deformable robotic surface as claimed in claim 1 further comprising at least one additional layer or skin.

88. A physically deformable robotic surface as claimed in claim 87 wherein the additional layer or skin covers at least a portion of the covering.

89. A physically deformable robotic surface as claimed in claim 87 wherein the movement of the covering, additional layer, or exterior surface through time generally correspond to a computer represented movement of the faces of the computer representation through time.

90. A physically deformable robotic surface as claimed in claim 1, wherein the control points are integrally formed with the covering.

91. A physically deformable robotic surface as claimed in claim 1 wherein the control points correspond to vertices of a computer representation, the covering corresponds to a face or series of faces of the computer representation.

92. A physically deformable robotic surface as claimed in claim 91 wherein the control points correspond to vertices of a computer representation, the control point connectors correspond to edges of the computer representation, the covering, additional layer, or exterior surface corresponds to a face or series of faces of the computer representation.

93. A combination of a deformable robotic surface as claimed in claim 1 attached to at least one other deformable robotic surface as claimed in claim 1.

94. A combination of a physically deformable robotic surface as claimed in claim 1 attached to at least one other item.

95. A combination as claimed in claim 94 wherein the other item is part of a robot.

96. A combination as claimed in claim 94, wherein the other item is part of a non-deformable surface.

97. A combination as claimed in claim 95, wherein the physically deformable robotic surface forms the exterior surface or artificial skin of the robot.

98. A combination as claimed in claim 97 wherein the layout of control points generally flow in the same direction of the underlying superficial muscle structure of an organism.

99. A combination as claimed in claim 97 wherein the layout of the control points is determined by the range of motion of the organism.

100. A combination as claimed in claim 97 wherein information gathered from a surveyed organism can be used to determine the control point and control point layout of the physically deformable robotic surface.

101. A combination as claimed in claim 97 wherein DNA from an organism can be used to determine the control point and control point layout of the physically deformable robotic surface.

102. An artificial muscle comprising a physically deformable robotic surface as claimed in claim 1.

103. An artificial muscle as claimed in claim 102 further comprising an artificial muscle core wherein the physically deformable robotic surface at least partially surrounds the artificial muscle core.

104. A combination of a physically deformable robotic surface as claimed in claim 1 wherein the deformable robotic surface is filled with air, fluids, or other materials.

105. A combination of a physically deformable robotic surface as claimed in claim 1 wherein the deformable robotic surface has at least one decoration attached to the surface.

106. A physically deformable robotic surface comprising:
a plurality of control points, the control points being moveable relative to each other;
a covering extending between the plurality of control points;
sensors, electronic components, electronic circuits, and wiring to transfer data, and/or energy for transferring actuation to and/or from the plurality of control points;
wherein movement of the control points relative to each other causes a corresponding movement of the covering.

107. A physically deformable robotic surface comprising:
a plurality of control points, the control points being moveable relative to each other;
a covering extending between the plurality of control points; and
an additional layer extending over at least a portion of the deformable robotic surface;
wherein movement of the control points relative to each other causes a corresponding movement of the covering;
and wherein the additional layer is adapted to cause movement of the at least a portion of the deformable robotic surface in addition to the movement of the control points.

108. A physically deformable robotic surface as claimed in claim 107, wherein the additional layer comprises an actuator.

109. A physically deformable robotic surface as claimed in claim 108, wherein the actuator comprises an electroactive polymer.

110. A physically deformable robotic surface comprising:
a plurality of control points, the control points being moveable relative to each other;
an actuating support surface adapted to move the control points relative to each other;
a covering extending between the plurality of control points;
wherein movement of the actuating support surface causes movement of the control points relative to each other and a corresponding movement of the covering.

111. A physically deformable robotic surface as claimed in claim 110, wherein the actuating support surface comprises an electroactive polymer.

112. A physically deformable robotic surface comprising:
a plurality of control points, the control points being moveable relative to each other:
a covering extending between the plurality of control points; and
a plurality of connectors for attaching the physically deformable robotic surface to a plurality of connectors of another physically deformable robotic surface;
wherein movement of the control points relative to each other causes a corresponding movement of the covering.

113. A physically deformable robotic surface as claimed in claim 112 further comprising a plurality of control point connectors, each control point connector connecting two control points of the plurality of control points.

114. A physically deformable robotic surface as claimed claim 113 wherein the connectors for attaching the physically deformable robotic surface to the other physically deformable robotic surface comprise an edge of each of at least a portion of the plurality of control point connectors.

115. A physically deformable robotic surface as claimed in claim 114 wherein the connectors for attaching the physically deformable robotic surface to the other physically deformable robotic surface comprise at least a portion of the plurality of control points.

116. A physically deformable robotic surface as claimed in claim 115 wherein the plurality of connectors comprise at least one edge of the covering of the physically deformable robotic surface.

117. A physically deformable robotic surface comprising:
a plurality of control points, the control points being moveable relative to each other;
a plurality of control point connectors extending between the control points, each control point connector connecting two control points of the plurality of control points, at least a portion of the control point connectors comprising connector actuators that are adapted to move the control points relative to each other;
a covering extending between the plurality of control points and the control point connectors;
wherein movement of the control points relative to each other causes a corresponding movement of the control point connectors and the covering.

118. A physically deformable robotic surface as claimed in claim 117 wherein the connector actuators comprises biasing means, electroactive polymers, mechanical and/or pneumatic actuators.

119. A physically deformable robotic surface as claimed in claim 118 wherein the biasing means comprises a spring.
